(19) United States
(12) Patent Application Publication
(10) Pub. No.: US 2026/0289584 A1
(43) Pub. Date: Sep. 24, 2026

(54) SYSTEM

(71) Applicant: SoftBank Group Corp., Tokyo (JP)

(72) Inventor: Hiroyuki YAMAUCHI, okyo (JP)

(73) Assignee: SoftBank Group Corp., Tokyo (JP)

(21) Appl. No.: 19/568,936

(22) Filed: Mar. 17, 2026

(30) Foreign Application Priority Data
Mar. 19, 2025 (JP) 2025-045172

(51) Int. Cl. G06Q 30/018; G06F 16/3329; G06Q 10/0637

(52) U.S. Cl. CPC G06Q 30/018; G06F 16/33295; G06Q 10/06375

(57) ABSTRACT

A system includes a processor that is configured to obtain law revision information from an external information source and analyze the obtained law revision information, generate a prompt, based on a result of the analyzing, for instructing a generative AI model to create an improvement plan or a countermeasure plan, and collect user emotion data by using an emotion engine to recognize a user emotion, analyze the collected user emotion data, and propose a business improvement plan based on a result of analyzing the collected user emotion data.

### CROSS-REFERENCE TO RELATED APPLICATION

This application is based on and claims priority under 35 USC 119 from Japanese Patent Application No. 2025-045172 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional compliance support systems for responding to revisions of laws and regulations generally rely on manual analysis performed by legal or compliance personnel. Such systems require human experts to monitor external information sources, interpret complex legal texts, identify affected business operations, and draft corresponding improvement plans or countermeasure plans. As a result, the response to law revisions is often time-consuming, labor-intensive, and prone to omissions or delays. In addition, conventional systems do not sufficiently take into account user emotions or psychological responses when proposing business improvement plans, and therefore may fail to generate measures that are acceptable to end users or that support smooth organizational change. Furthermore, existing approaches often do not effectively leverage generative AI models and AI-based learning in an integrated manner for both legal analysis and proposal generation. Accordingly, there is a need for a system that can automatically obtain and analyze law revision information from external information sources, generate prompts for instructing a generative AI model to create improvement and countermeasure plans, and also recognize and analyze user emotions so as to propose appropriate business improvement plans, thereby enabling efficient, accurate, and user-aligned responses to law revisions.

### SUMMARY

In order to solve the above-described problems, according to one aspect of the present invention, there is provided a system comprising a processor, wherein the processor is configured to obtain law revision information from an external information source and analyze the obtained law revision information, generate a prompt, based on a result of the analyzing, for instructing a generative AI model to create an improvement plan or a countermeasure plan, and collect user emotion data by using an emotion engine to recognize a user emotion, analyze the collected user emotion data, and propose a business improvement plan based on a result of analyzing the collected user emotion data. In one embodiment, the processor is configured to obtain information from the external information source and analyze the obtained information in order to identify a business operation related to a law revision by using learning by AI, thereby automatically determining which operations are affected by a particular legal change. In another embodiment, the processor is configured to generate, by using learning by AI, the prompt for instructing the generative AI model to create the improvement plan or the countermeasure plan, and to automatically create the improvement plan or the countermeasure plan by using the prompt. Through these configurations, the system can automatically link law revision information with internal business operations, generate appropriate improvement and countermeasure plans using a generative AI model, and refine or adapt such plans based on user emotion analysis, thereby providing an integrated solution for rapid, accurate, and user-sensitive compliance and business process improvement.

The term “system” refers to an integrated arrangement of hardware, software, and communication components that cooperatively execute processing for obtaining, analyzing, and utilizing law revision information, user emotion data, and generative AI outputs. The term “processor” refers to one or more hardware processing units, such as a central processing unit (CPU), a graphics processing unit (GPU), a microprocessor, or a combination thereof, capable of executing instructions to perform the functions described in the claims. The term “external information source” refers to any source of information located outside the system, including but not limited to online legal databases, governmental web services, third-party information services, and external document repositories, from which law revision information or related information can be obtained.

The term “law revision information” refers to information regarding a new enactment, amendment, repeal, or other change to a law, regulation, rule, guideline, or similar legal or quasi-legal instrument, including full text, summaries, metadata, and associated references.

The term “analyze” or “analyzing” refers to processing input information to extract features, structures, relationships, classifications, or meanings, including but not limited to natural language processing, parsing, semantic analysis, statistical analysis, and machine learning-based inference.

The term “generative AI model” refers to an artificial intelligence model, such as a large language model or other generative neural network, that is capable of generating text or other content in response to input data and prompts.

The term “prompt” refers to a set of input data, instructions, or conditions supplied to the generative AI model, which defines or constrains the content, style, or scope of output generated by the generative AI model.

The term “improvement plan” refers to a proposal or set of proposed actions for modifying or optimizing a business operation, process, or workflow in order to enhance compliance, efficiency, usability, or other performance metrics.

The term “countermeasure plan” refers to a proposal or set of proposed actions specifically directed to mitigating, preventing, or correcting risks, non-compliance, or adverse impacts arising from a law revision or from changes in legal requirements.

The term “emotion engine” refers to a software or hardware module, or a combination thereof, configured to detect, infer, or estimate a user's emotional state based on input data such as text, voice, facial expressions, physiological signals, or interaction patterns.

The term “user emotion data” refers to data representing or associated with a user's emotional state, including raw signals acquired for emotion recognition and processed or inferred emotion labels, scores, or profiles obtained by the emotion engine.

The term “business improvement plan” refers to an improvement plan that targets one or more business operations, processes, or organizational practices, and that is intended to enhance compliance with law revisions and to improve operational performance, taking into account user emotions or user acceptance.

The term “learning by AI” refers to a process in which an artificial intelligence model adjusts internal parameters or constructs internal representations based on training data, examples, or feedback, including but not limited to supervised learning, unsupervised learning, reinforcement learning, and continual learning.

The term “business operation” refers to any task, activity, workflow, or process performed within an organization, including, for example, human resources operations, payroll processing, data management, compliance procedures, and related administrative or operational activities.

The term “law revision” refers to any change in legal requirements, including the introduction of a new law, an amendment to an existing law, the repeal of an existing law, or the issuance or modification of regulations, rules, guidelines, or equivalent normative documents.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

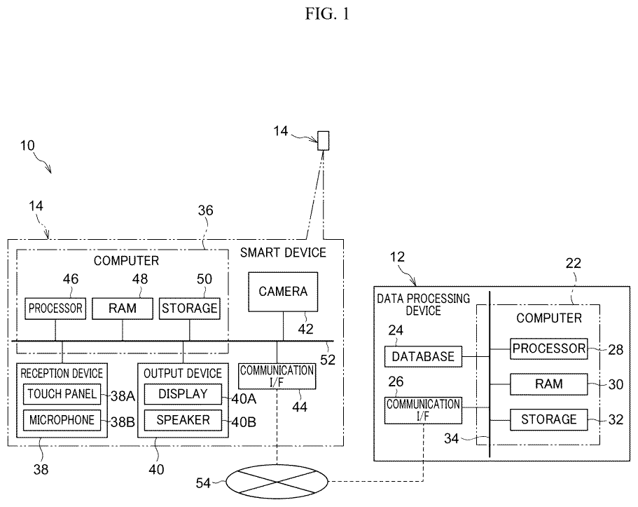

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

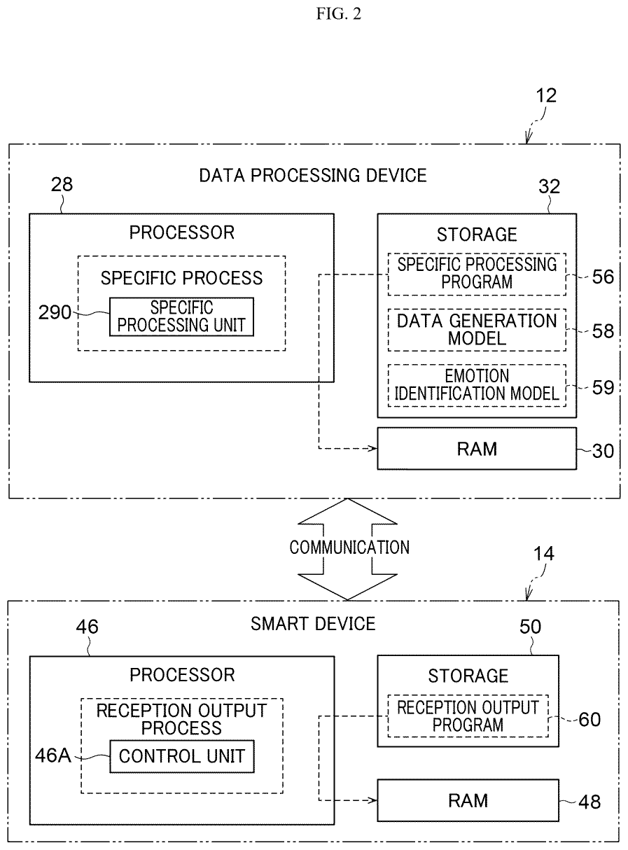

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional systems that analyze legal or regulatory revisions and derive corresponding business countermeasures largely rely on manual interpretation by human experts and simple rule-based engines. Such systems typically ingest legal texts in an ad hoc manner, provide limited linkage between legal requirements and detailed internal business procedures, and do not systematically leverage machine learning models or generative artificial intelligence models. As a result, it is difficult to accurately and efficiently determine which specific business units, workflows, and procedure elements are affected by a given legal revision, especially in large organizations with complex processes and heterogeneous information systems.

In addition, known systems do not provide an integrated mechanism for automatically generating machine-readable, context-rich prompt sentences for generative artificial intelligence models based on structured impact analysis results. Prompt construction is often performed manually by users or by static templates that do not adapt based on historical performance or feedback. This leads to suboptimal utilization of generative artificial intelligence models, inconsistent quality of proposed improvement measures and countermeasure plans, and increased burden on users to refine and reissue prompts. Further, existing solutions generally do not incorporate user state information, such as user emotion data, into the technical pipeline of impact analysis and countermeasure generation. User feedback, when present, is handled as a separate, non-technical layer and is not tightly integrated into the data structures and computational logic that drive the generation, evaluation, and refinement of improvement measures. Consequently, the system cannot technically optimize the interaction experience or prioritize and present output in a manner that reflects user understanding, acceptance, or stress levels, thereby limiting the practical effectiveness of the generated measures.

Moreover, there is a lack of a unified computer-implemented architecture that: (i) collects and normalizes business procedure information from multiple internal information processing devices, (ii) constructs and trains a machine learning model to compute impact degrees between legal revisions and business procedures, (iii) converts the resulting structured impact data into optimized prompt sentences for a generative artificial intelligence model, (iv) aggregates and structures generated improvement measures as machine-usable output data, and (v) correlates such output data with user emotion data for further analysis and proposal refinement. The absence of such an integrated technical architecture results in redundant processing, fragmented data representations, and inefficient use of computing resources. Accordingly, there is a need for a computer-implemented system and method that technically improve the way a computer acquires, normalizes, and structures business procedure data; computes impact degrees between legal revisions and business processes using a machine learning model; automatically generates and refines prompt sentences for a generative artificial intelligence model; and integrates user emotion data into the analysis and proposal pipeline. Such a system should reduce processing latency, improve the accuracy and consistency of impact predictions and generated measures, and enhance the overall efficiency and reliability of computer-based legal impact management.

The specific processing by the specific processing unit 290 of the data processing device 12 in Example 1 is realized by the following means.

The present invention provides a server comprising a processor configured to acquire and analyze legal revision information from an external information source; to acquire, from an internal business processing device and an internal information storage device, business procedure information and organization information associated with the legal revision information, to normalize the business procedure information, and to store the normalized business procedure information on a business unit basis and on a procedure unit basis in a structured storage; to construct and train a machine learning model based on the stored business procedure information and the legal revision information, and to calculate, by executing classification or regression processing by the machine learning model, an impact degree indicating an influence of a legal revision on each business; to specify, based on the impact degree, an affected business and an element of a business procedure of the affected business, and to store a specification result as structured data that links the legal revision information, the business, and the business procedure element; to automatically generate, from input data including the structured data and the legal revision information, a prompt sentence for instructing a generative artificial intelligence model to create improvement measures and countermeasure plans, to transmit the prompt sentence to the generative artificial intelligence model, and to store generation history of the prompt sentence as record information; to acquire output of the generative artificial intelligence model including the improvement measures and the countermeasure plans, to associate the improvement measures and the countermeasure plans with the specified business and business procedure element, to aggregate and format the associated improvement measures and countermeasure plans as output data suitable for presentation and further machine processing; and to acquire user emotion data by using an emotion processing device that performs emotion estimation processing to obtain user state information, to associate the user emotion data with the improvement measures and the countermeasure plans, to analyze the associated data, and to generate business improvement proposals that reflect both the computed impact degree and the user emotion data. This enables technical improvement of computer-based legal impact analysis and response generation by providing a unified data pipeline and computational architecture that (i) normalizes and structures heterogeneous business procedure information, (ii) automatically computes and stores machine-readable impact degrees between legal revisions and business procedures via a trained machine learning model, (iii) automatically constructs and refines prompt sentences for a generative artificial intelligence model based on structured impact data and prompt generation history, (iv) produces consistent, machine-usable improvement measures and countermeasure plans with reduced manual intervention, and (v) integrates user emotion data into the computational loop to optimize the presentation and prioritization of proposals, thereby enhancing processing efficiency, prediction accuracy, and overall system usability.

The term “processor” refers to a hardware-implemented computation unit, such as a central processing unit or other information processing circuitry, configured to execute instructions of a program to perform data acquisition, analysis, model execution, and control of other components of the system.

The term “external information source” refers to an information providing apparatus or service, such as an external server, database, or application programming interface, that supplies legal revision information or related regulatory data to the system via a communication network.

The term “legal revision information” refers to data representing a change in a legal rule, regulation, or policy, including at least one of a new enactment, an amendment, a repeal, or an update of a legal provision, and may include a text of the change, a summary, an effective date, and an applicability condition.

The term “business procedure information” refers to data representing an internal operational process of an organization, including at least one of a workflow, a task sequence, a step description, a role allocation, a business rule, and a reference to an external requirement. The term “organization information” refers to data representing a structure or attribute of an organization, including at least one of a department, a division, a role, a responsibility, or a hierarchical relationship associated with business procedures.

The term “business processing device” refers to an information processing apparatus, such as an application server, a transaction processing system, or an enterprise resource planning system, that executes business procedures and provides business-related data to the processor. The term “information storage device” refers to a data storage apparatus, such as a database system, a file storage system, or a storage medium, that stores business procedure information, organization information, or legal revision information in a machine-readable form.

The term “normalize” refers to processing data to transform heterogeneous or unstructured data into a standardized, structured format, including at least one of unifying field names, resolving duplicates, segmenting procedures into units, and assigning identifiers to business units and procedure units.

The term “business unit” refers to a logically grouped set of business activities or functions within an organization, such as a department or function area, that is treated as a unit for analysis and management.

The term “procedure unit” refers to a smallest analysis unit of a business procedure, such as an individual step, task, or operation within a larger workflow, which can be independently identified and associated with legal or organizational attributes.

The term “machine learning model” refers to a parameterized computational model, implemented by software and executed by the processor, that is configured to learn patterns from training data and to perform prediction or classification, including at least one of a neural network model, a decision tree model, or a regression model.

The term “impact degree” refers to a numerical or categorical indicator computed by the machine learning model that represents a predicted influence level of a legal revision on a particular business or business procedure, and may be expressed as a score, a probability, or a discrete category.

The term “structured data” refers to data organized according to a predefined schema, such as a table, a record, or a graph structure, in which relationships between legal revision information, business units, and procedure units are explicitly represented in machine-readable form.

The term “generative artificial intelligence model” refers to a computational model that, upon receiving an input prompt, is configured to generate natural language text or other content, and that is trained using machine learning techniques to produce improvement measures or countermeasure plans.

The term “prompt sentence” refers to a machine-generated or machine-processed natural language instruction or query that is supplied as input to the generative artificial intelligence model to specify a generation task, a context, or constraints for producing improvement measures or countermeasure plans.

The term “improvement measures” refers to proposed modifications or enhancements to business procedures, business rules, or system configurations, which are generated or selected by the system in order to better comply with a legal revision or to improve operational performance.

The term “countermeasure plans” refers to structured action plans or steps that specify how to modify, implement, or schedule changes to business procedures, systems, or policies in response to a legal revision or identified risk.

The term “output data” refers to data generated by the processor that aggregates, formats, and structures the improvement measures and the countermeasure plans, and is configured for presentation to a user or for further processing by another system.

The term “emotion processing device” refers to a hardware and software combination that performs emotion estimation processing, including at least one of analyzing biometric signals, user interaction patterns, or content of user inputs, to derive user emotion data as user state information.

The term “user emotion data” refers to data representing an estimated emotional state or attitude of a user, such as stress, satisfaction, confusion, or confidence, obtained by the emotion processing device and expressed in a quantitative or categorical form.

The term “user state information” refers to information that characterizes a condition of a user, including at least one of user emotion data, user engagement level, user interaction history, or user preference, which is used by the system to analyze and adapt output.

The term “business improvement proposals” refers to recommendations generated by the processor that integrate the computed impact degree, the improvement measures, the countermeasure plans, and the user emotion data, and that specify how to modify business procedures or interactions to improve compliance and usability.

The term “generation history” refers to record information that logs details of generated prompt sentences, including at least one of content, time, associated legal revision, associated business, and outcome quality indicators, for use in subsequent analysis or refinement.

The term “record information” refers to stored data representing a history of operations or outputs of the system, including generation history of prompt sentences and associated evaluation or feedback, which is used to adjust or optimize future processing.

The term “classification processing” refers to a computation executed by the machine learning model in which input data is assigned to one or more discrete categories, such as impact levels or affected business classes.

The term “regression processing” refers to a computation executed by the machine learning model in which a continuous value, such as a numerical impact degree score, is predicted from input data.

The term “organization attribute information” refers to data representing properties of an organizational unit, role, or function, such as size, responsibility domain, risk level, or criticality, which is associated with business procedures and used as part of prompt construction or model input.

The term “implementation deadline information” refers to data representing a required completion time or effective date for implementing improvement measures or countermeasure plans in response to a legal revision.

The term “display device” refers to an output apparatus, such as a monitor, a terminal screen, or a graphical user interface, that is configured to present the output data, including improvement measures, countermeasure plans, and business improvement proposals, to a user.

The term “communication device” refers to a hardware and software component that transmits or receives data via a communication network, including at least one of a network interface, a modem, or a communication module, used to notify a user of information from the system.

In one embodiment, a server executes a computer program stored in a non-transitory computer-readable medium to implement the claimed system. The server includes at least one processor, a main memory, a storage device, a network interface, and an interface to an external emotion processing device. The server operates in communication with one or more terminals operated by users. Each terminal includes a display device, an input device, and a communication interface, and may be implemented as a personal computer, a smartphone, or a tablet. The server further communicates with external information sources, such as external servers or databases providing legal revision information, via a communication network. The server uses a general-purpose operating system, such as a server-class operating system, and executes an application implemented, for example, in a programming language such as Java or Python. The server uses a relational database management system, such as a generic SQL database, as an information storage device to store business procedure information, organization information, legal revision information, structured impact data, prompt generation history, and generated recommendations. The server may additionally use a search engine, such as a generic full-text search engine, for indexing legal texts and procedure texts. The server uses software libraries for data processing and machine learning, such as a data analysis framework (for example, a library similar to pandas), a traditional machine learning library (for example, a library similar to scikit-learn), and a deep learning framework such as TensorFlow or PyTorch. The server optionally uses a natural language processing library, such as a library similar to spaCy or a transformer library similar to Hugging Face Transformers, to convert legal text and workflow descriptions into vector representations. The server communicates with a generative AI model via a network-accessible API, which may be provided by an external service or deployed on another server using an inference runtime.

The server acquires legal revision information from an external information source by issuing network requests through the network interface. The server receives legal texts, metadata such as effective date and article number, and structured fields such as thresholds and applicability conditions. The server parses these responses, stores them in the database as legal revision records, and indexes the full text for later retrieval. The server further tags the legal revisions with domain labels, such as labor-related or tax-related, by applying natural language processing and keyword extraction, which are implemented by processor-executed code.

The server acquires business procedure information and organization information from internal business processing devices and information storage devices. The business processing devices may include enterprise resource planning systems, human resource management systems, and accounting systems. The server connects to these devices using standardized interfaces such as REST APIs or database connectivity protocols. The business procedure information may include workflow definitions, step descriptions, role assignments, data field definitions, and references to external legal codes. The server normalizes this information by unifying naming conventions, segmenting complex workflows into procedure units, assigning identifiers to business units and procedure units, and mapping role names to standardized organizational roles. The server stores the normalized data into relational tables, such as a table for business units, a table for procedures, and a table for procedure steps. The server constructs and trains a machine learning model using TensorFlow or PyTorch. In one embodiment, the server uses a neural network architecture including an input embedding layer, one or more intermediate layers (such as recurrent layers, convolutional layers, or transformer encoder layers), and a final output layer. The input embedding layer converts text data, such as step descriptions and legal references, into dense numerical vectors using a pre-trained language model or an embedding matrix learned during training. The intermediate layers capture relationships between procedure steps, legal tags, and organizational attributes, and propagate these relationships to the output layer.

The server defines an objective function that measures the difference between predicted impact degrees and ground truth labels derived from historical data, such as known cases where particular legal revisions affected specific business procedures. The server uses a loss function such as cross-entropy for classification or mean squared error for regression. The server performs gradient-based optimization (for example, stochastic gradient descent or a variant such as Adam) to update model parameters. The processor executes these training steps repeatedly, loading batches of feature vectors from the database, calculating forward activations through the neural network, computing the loss, and updating the weights by backpropagation.

The server selects features for the machine learning model that include: numerical encodings of organizational attributes, binary indicators for the presence of specific legal concepts in procedure descriptions, counts of references to particular legal domains, and continuous features such as transaction volume or processing time. The server also constructs adjacency relationships between procedure units that appear in the same workflow, allowing the model to capture structural dependencies that typical rule-based engines cannot easily represent. By constructing and training this specific model architecture, the server improves the precision and recall of impact predictions, and reduces false positives compared to simpler rule-based filters.

The server computes an impact degree for each combination of legal revision and business procedure. The server uses the trained model to perform inference: the processor loads legal revision features and procedure features, executes the neural network to produce an output score, and writes the resulting impact degree into structured tables. The impact degree may be represented as a real-valued score or as a discrete level. The server stores the association between legal revision identifiers, business units, procedure units, and impact degrees in structured data, such as a table or a graph-like structure.

The server then generates structured impact explanations by analyzing contributions of different features or activations. For example, the server may compute attention weights over text tokens or feature importance scores, and record which legal phrases and procedure elements contributed most to the impact degree. The server stores this explanation data as structured metadata, which can later be used to generate more targeted prompt sentences and to provide interpretability to users at terminals.

The server constructs prompt sentences for a generative AI model by assembling information from multiple tables: a legal revision record, a set of affected business procedures with impact degrees, organizational attributes, and implementation deadlines. The server uses a dedicated prompt generation module that applies deterministic rules and optional learned patterns to map structured fields into natural language segments. The server also consults a prompt generation history table to adjust phrasing, ordering of information, or level of detail based on past performance metrics or user feedback.

In one example, the server generates a prompt sentence as follows:
“Latest labor law revision impact analysis:
Law change: The maximum weekly working hours are reduced from 44 to 40 hours for full-time employees, effective on [date].

### Internal Workflows:

1. HR shift management: handles shift assignment and overtime approval for production workers, implemented in [system name].
2. Payroll calculation: calculates base salary and overtime payments for all employees, implemented in [system name].

As a generative AI model specializing in compliance and HR processes, identify the specific points in these workflows and systems that must be changed to comply with the new limit. Provide concrete rule changes, example configurations, and a short risk assessment.”

In another example, the server generates a prompt sentence:

“You are a generative AI model acting as a corporate tax and accounting advisor.

Tax law revision: [insert detailed tax law change].

The following workflows are related:
Accounts payable processing
VAT reporting
Monthly closing and financial reporting

Analyze the impact of the revision on each workflow, and output a prioritized list of actions that the accounting department should take within the next 30 days, 90 days, and 1 year.” In another example, the server generates a prompt sentence for internal communication: “Given this legal revision and the list of impacted workflows below, draft an internal communication email to employees explaining the changes in working hours and overtime rules in clear, non-legal language. The email should be suitable for all staff, including factory workers and office workers.”

The server records each prompt sentence, together with identifiers of the corresponding legal revision and affected procedures, into a prompt history table. The server may store additional metadata such as length of the response, user satisfaction ratings, and whether follow-up prompts were required. The server analyses this record data to iteratively refine prompt templates, for example by modifying the ordering of sections, adding explicit constraints, or adjusting the level of detail. This feedback-driven prompt generation mechanism improves the effectiveness and consistency of generative AI outputs in a way that is not easily achieved through manual prompt design.

The server sends the constructed prompt sentence to the generative AI model via a network request. The generative AI model processes the prompt and returns generated text representing improvement measures and countermeasure plans. The server receives the generated text and parses it by detecting headings, bullet lists, or specified delimiters. The server associates each generated measure with corresponding business units and procedure units, using identifiers and keywords present in the prompt and response. The server stores the generated measures and plans in a structured format, which may include fields such as target system, configuration parameter, rule description, implementation steps, and priority level.

The server aggregates the generated measures by legal revision, department, and impact level, and formats them into output data suitable for consumption by terminals and other systems. By treating these generated outputs as structured data rather than free text, the server enables downstream technical processing, such as automated scheduling of configuration changes or integration with ticketing systems. This structured aggregation improves data management by providing consistent schemas and enabling efficient querying and filtering of generated plans.

The server acquires user emotion data from an emotion processing device connected via the network. The emotion processing device may include sensors, such as cameras or microphones, and executes software capable of estimating user emotion states from biometric signals or interaction patterns. The server receives emotion scores or categories, such as stress level or confidence, associated with user identifiers and time stamps. The server links this emotion data to specific system outputs, such as particular prompts, analysis results, or recommendations displayed to the user at the terminal.

The server analyzes correlations between user emotion data and types of recommendations. For example, if a particular style of explanation or level of detail consistently correlates with reduced confusion or stress, the server adjusts its presentation formats and prompt construction accordingly. The server also may adjust prioritization or grouping of recommendations based on emotion metrics, thereby improving user experience and decreasing cognitive load. These operations are executed by the processor according to defined algorithms, and they modify internal data structures and communication patterns between server and terminal, which results in a technical improvement in interaction management and system responsiveness.

The terminal receives output data from the server through the network. The terminal renders a user interface, such as a dashboard, that displays a list of legal revisions, affected business units, impact levels, and generated improvement measures. The user selects a legal revision and views a detailed screen showing specific procedure steps, predicted impact degrees, and associated countermeasure plans. The terminal allows the user to provide feedback, such as marking a recommendation as accepted, rejected, or unclear, and to enter additional instructions or constraints. The terminal transmits this feedback to the server, which stores it in feedback tables and uses it to refine both the machine learning model and the prompt generation logic.

The server uses the feedback data as labeled examples for further training or fine-tuning of the machine learning model. For example, if certain predictions repeatedly lead to rejected recommendations, the server may adjust training weights or re-evaluate feature selection for those cases. The server may also use feedback to adjust the target loss function by weighting examples according to their practical relevance or importance. This adaptive learning process improves prediction accuracy and reduces error rates over time, thereby demonstrating a technological improvement over static rule-based systems.

The server architecture includes multiple modules: a data ingestion module for legal and procedure data, a normalization module, a feature extraction module, a machine learning training and inference module, a prompt generation module, a generative AI integration module, an emotion integration module, and an output formatting and notification module. Each module communicates via well-defined data structures, such as relational tables, message queues, or serialized objects. By organizing processing in this modular pipeline, the server reduces redundant data transformations, improves cache utilization, and enables parallel execution of independent tasks, resulting in reduced processing latency and improved throughput.

In another embodiment, the server uses a different neural network architecture, such as a graph neural network that operates on a graph representation of workflows and legal concepts. Nodes in the graph represent procedure units and legal clauses, and edges represent references or dependencies. The server computes node embeddings using message passing algorithms and trains the model with a loss function that encourages accurate prediction of impacted nodes for given legal changes. This architecture allows the server to capture relational structure more precisely than linear models, leading to improved impact prediction and more targeted prompt content.

In another embodiment, the server employs an ensemble of models, such as combining a gradient boosting model operating on tabular features with a deep neural network operating on text embeddings. The server aggregates predictions from these models using a weighted scheme, which can be optimized based on validation performance. This ensemble approach increases robustness and reduces variance in predictions, thus further lowering false positives and negatives compared to a single model.

In yet another embodiment, the server performs data augmentation by generating synthetic variations of business procedure descriptions or legal statements, using text augmentation techniques such as paraphrasing or synonym replacement. The server uses these augmented examples during training to improve generalization, particularly for rare types of legal revisions. By expanding the training distribution, the server reduces overfitting and improves model performance on unseen legal changes.

The described system provides more than an automation of human tasks; it implements a specific sequence of technical operations—including structured data normalization, specialized feature extraction, model-based impact computation, prompt generation with historical optimization, and emotion-informed output adaptation—that improves the functioning of the computer system itself. The server reduces processing time by using optimized data schemas and parallelizable pipelines, improves accuracy by leveraging advanced neural architectures and feedback-driven refinement, and enhances data management through explicit structured representations and logging of prompt and response histories. These improvements are realized in the internal operation of the server and its interaction with terminals and devices, and are not simply the automation of mental processes.

The user operates the terminal to review impact analyses, to input constraints and preferences, and to trigger additional prompt-based refinement. The user, for example, may request a more technically detailed implementation plan for configuring a specific internal system. The server receives this request, augments the existing structured data with the user's additional instructions, and generates a new prompt sentence that references prior analysis and recommendations. The generative AI model returns a refined plan, which the server parses and structures. This iterative loop between server and generative AI model, mediated by structured prompts and recorded histories, provides a dynamic mechanism for improving the quality and specificity of generated plans while maintaining traceable, machine-usable records.

Through these embodiments and variations, the server, terminals, and associated devices cooperate to realize the claimed invention. The system thus provides a concrete technical implementation that can be realized using general-purpose hardware and specific software configurations described above, and that yields technical effects in terms of improved processing efficiency, accuracy, data organization, and interaction quality.

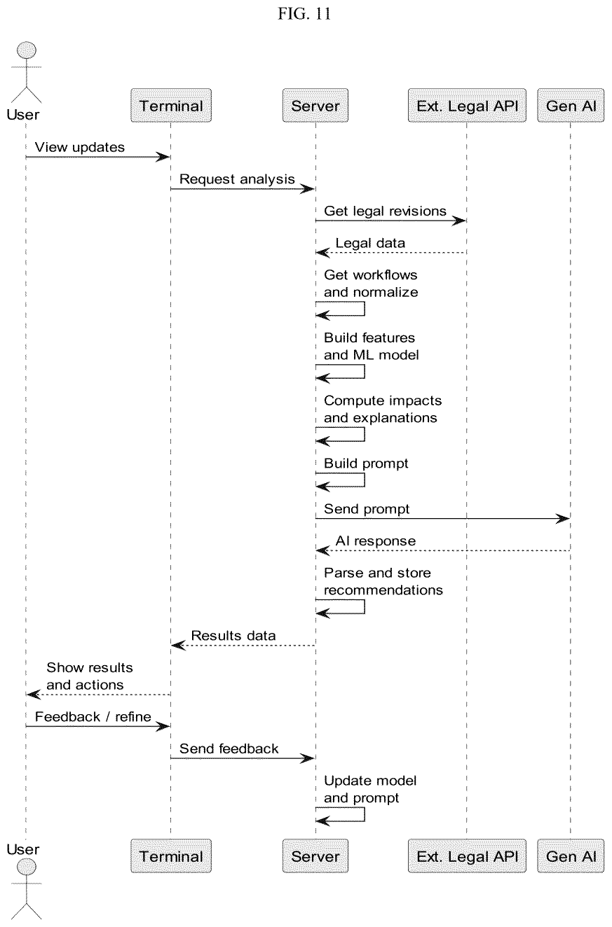

The following describes the processing flow using FIG. 11.

### Step 1:

The server acquires legal revision information from an external information source. The server sends an HTTP request including an identifier of a legal domain (for example, labor or tax) and a date range as input. The server receives a response that includes legal text, article identifiers, effective dates, and structured fields as output. The server parses the response, converts the content into internal records by mapping fields to a predefined schema, and stores the parsed records in a database table for legal revisions.

### Step 2:

The server acquires business procedure information and organization information from internal business processing devices and information storage devices. The server uses, as input, connection parameters and authentication credentials configured for each internal system. The server executes queries or API calls to obtain workflow definitions, step descriptions, role assignments, and organizational structures as output. The server writes the retrieved data into temporary staging tables for later normalization.

### Step 3:

The server normalizes the acquired business procedure information. The server uses, as input, the raw workflow records stored in the staging tables. The server performs data cleansing, including removing duplicate entries, unifying field names, and splitting complex workflow descriptions into discrete procedure units. The server assigns unique identifiers to business units and procedure units and resolves inconsistent role names by mapping them to standard organization roles, thereby producing normalized workflow tables as output.

### Step 4:

The server links business procedure information with legal concepts and organization information. The server takes as input the normalized workflow tables and a list of legal terms or tags extracted from the legal revision information. The server applies keyword matching and natural language processing to detect references to legal concepts in procedure descriptions. The server generates, as output, association records that link each procedure unit with one or more legal tags and with organization attributes, such as department or risk category.

### Step 5:

The server constructs feature vectors for training a machine learning model. The server uses, as input, the association records, normalized procedure data, organization attributes, and historical labels indicating known impacts of past legal revisions. The server converts text fields into numerical embeddings using a text embedding model, encodes categorical attributes as one-hot or index-based vectors, and scales numerical attributes. The server concatenates these encodings into fixed-length feature vectors and outputs a training dataset consisting of feature vectors and corresponding labels.

### Step 6:

The server trains a machine learning model to compute impact degrees. The server uses the training dataset as input and initializes a neural network model implemented in a deep learning framework. The server performs repeated training iterations, where in each iteration the server passes a batch of feature vectors through the model, calculates a loss value using a loss function such as cross-entropy or mean squared error, and updates the model weights using a gradient-based optimizer. The server outputs a trained model, together with stored model parameters and performance metrics.

### Step 7:

The server calculates impact degrees for new legal revisions. The server uses, as input, the trained model, the newly acquired legal revision information, and the normalized business procedure information. The server constructs feature vectors for each combination of a legal revision and a procedure unit using the same encoding rules as during training. The server executes the trained model in inference mode to generate an impact score or category for each combination as output. The server stores these impact degrees in an impact analysis table linked to legal revision identifiers and procedure unit identifiers.

### Step 8:

The server creates structured impact explanation data. The server uses, as input, the impact degrees and internal model outputs, such as attention weights or intermediate activations. The server analyzes which features, tokens, or attributes contributed most to each impact prediction by computing contribution scores or reading attention distributions. The server generates, as output, structured explanation records that identify the influential legal phrases, procedure steps, and organization attributes for each impacted procedure.

### Step 9:

The server selects affected business units and procedure units based on impact degrees. The server uses, as input, the impact analysis table and a set of predefined thresholds or selection rules. The server filters combinations where the impact degree exceeds a threshold or falls into specific categories, and groups the results by business unit and department. The server outputs a list of affected business units, affected procedure units, and their impact levels, which are stored as structured data.

### Step 10:

The server aggregates structured impact data for prompt construction. The server uses, as input, the list of affected units, the legal revision summaries, the structured explanations, and organization attributes such as department names and system identifiers. The server merges these data elements into an intermediate representation that groups impacted workflows by legal revision and department. The server outputs an impact summary object that contains all information needed for generating a prompt sentence.

### Step 11:

The server generates a prompt sentence for a generative AI model. The server uses the impact summary object and a prompt template as input. The server inserts legal revision summaries, workflow names, department information, and effective dates into placeholder positions in the template. The server may also include explanation snippets that highlight why a workflow is impacted. The server outputs a natural language prompt sentence that describes the legal change, lists the affected workflows, and specifies the required output from the generative AI model.

### Step 12:

The server records prompt generation history. The server uses, as input, the generated prompt sentence, the identifiers of the corresponding legal revision and affected workflows, and metadata such as generation time and template version. The server writes these values into a prompt history table. The server outputs an updated prompt history that can later be used to refine prompt templates and to analyze performance.

### Step 13:

The server sends the prompt sentence to the generative AI model. The server uses, as input, the prompt sentence and API endpoint configuration for the generative AI model. The server generates a request payload that encodes the prompt sentence and any control parameters (such as maximum length or temperature). The server transmits the request over the network and receives, as output, generated text containing improvement measures, countermeasure plans, or explanations.

### Step 14:

The server parses and structures the output from the generative AI model. The server uses, as input, the generated text and the original prompt sentence. The server applies text parsing rules, such as detecting headings, bullet markers, or keywords, to segment the generated text into individual recommendations. The server associates each recommendation with the impacted workflows by matching identifiers or names included in the text. The server outputs structured recommendation records containing fields such as target business unit, target procedure, action description, priority, and suggested timeline.

### Step 15:

The server aggregates recommendations for presentation and further processing. The server uses, as input, the structured recommendation records and impact degrees. The server groups recommendations by department, impact level, and legal revision, and sorts them according to priority or implementation deadline. The server produces, as output, aggregated recommendation sets that are formatted for efficient retrieval by terminals and potential integration with other systems.

### Step 16:

The server acquires user emotion data from an emotion processing device. The server uses, as input, identifiers of users who are interacting with the system and time windows corresponding to display or interaction events. The server receives emotion metrics, such as stress level or confidence score, from the emotion processing device as output. The server associates each emotion record with specific recommendations or screens displayed to the user at that time.

### Step 17:

The server analyzes correlations between user emotion data and system outputs. The server uses, as input, the emotion records and the aggregated recommendation sets. The server computes statistics such as average stress level per recommendation type, or response time per level of detail. The server produces, as output, adaptation parameters, such as recommended verbosity levels, preferred explanation styles, or prioritization adjustments based on emotion trends.

### Step 18:

The server adapts presentation formats and prompt generation based on emotion analysis and feedback. The server uses, as input, the adaptation parameters, the prompt history, and user feedback records indicating accepted or rejected recommendations. The server updates prompt templates by adjusting wording, adding constraints, or changing the order of information. The server also updates presentation profiles that determine how recommendations are displayed on the terminal. The server outputs updated templates and profiles that will be used in subsequent prompt generation and display.

### Step 19:

The server sends aggregated recommendations and related information to the terminal. The server uses, as input, the aggregated recommendation sets, impact explanations, and current presentation profiles. The server prepares response data, such as JSON or another structured format, that includes lists of legal revisions, impacted workflows, recommendations, and explanation texts. The server transmits this response to the terminal, which receives it as output and stores it temporarily for rendering.

### Step 20:

The terminal renders a user interface showing analysis results and recommendations. The terminal uses, as input, the response data from the server and the presentation profile associated with the current user. The terminal generates user interface components such as lists, tables, and detail views for each legal revision and workflow. The terminal displays recommended actions, impact levels, and explanations on the screen as output and provides controls for the user to accept, reject, or request clarification for each recommendation.

### Step 21:

The user reviews recommendations and provides feedback or additional instructions. The user uses the terminal interface as input, selecting items, clicking buttons, and entering text comments. The user may mark certain recommendations as implemented, request more detailed technical instructions, or specify constraints such as budget or time limitations. The terminal sends this feedback data to the server as output, including identifiers of affected recommendations and user comments.

### Step 22:

The server processes user feedback for model and prompt refinement. The server uses, as input, the user feedback, corresponding recommendation records, and prompt history. The server labels certain predictions as successful or unsuccessful based on user acceptance, and updates training datasets or validation metrics accordingly. The server also modifies prompt templates to address recurring user requests, such as adding explicit technical steps or clarifying assumptions. The server outputs updated training data, updated model evaluation metrics, and revised prompt templates.

### Step 23:

The server optionally generates a refinement prompt based on prior output and user instructions. The server uses, as input, an existing set of recommendations, user comments requesting more detail or a different focus, and the corresponding legal revision data. The server composes a new prompt sentence that includes the prior recommendations and the user's additional instructions. The server outputs a refinement prompt, which is then sent to the generative AI model to obtain a more detailed or tailored plan.

### Step 24:

The server updates stored recommendations and output data with refined results. The server uses, as input, refined generated text from the generative AI model and the existing structured recommendation records. The server replaces or augments the original recommendations with the refined ones, preserving links to workflows, legal revisions, and feedback history. The server outputs updated recommendation sets that reflect the latest refined content and are made available to the terminal for display to the user.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In conventional compliance support systems, a processor typically ingests legal texts and displays them to human operators, who then manually interpret the impact of a legal system revision on internal business rules and draft corresponding improvement measures. Such systems merely digitize documents and workflows but do not fundamentally improve the core information-processing technology used to map unstructured legal text to structured internal policies and actionable countermeasures. As a result, these systems suffer from several technical problems.

First, conventional systems do not provide an efficient and accurate mechanism for transforming large volumes of unstructured legal text into structured data suitable for automated impact analysis. The processor often treats legal text as opaque character strings, leading to ad-hoc keyword searches and brittle rule-based logic. This causes increased computational overhead due to repetitive parsing, low recall and precision in identifying affected business rules, and a need for repeated human intervention, which in turn degrades throughput and latency of the overall system.

Second, conventional systems that employ machine learning or generative models typically do so in a static, monolithic manner. A generative model is usually invoked with fixed, manually written prompts that are not adapted to the specific structure of the input data, the organization's internal rule set, or user feedback. Because the prompts are not automatically structured or optimized, the generative model tends to produce verbose, inconsistent, or misaligned outputs. This leads to additional post-processing, frequent re-runs of inference, and inefficient use of processing resources such as central processing units and accelerators. Third, existing systems generally lack a robust mechanism for aligning the free-form text output of a generative model with an internal repository of business rules maintained in structured storage. Without a technical process for systematically computing similarity between generated descriptions and stored rule records, mappings must be manually curated or handled by simple keyword matching. This causes incorrect associations, duplicated work, and a need for human review that scales poorly with the number of legal revisions and internal rules, thereby limiting scalability and responsiveness of the system under high update rates.

Fourth, conventional systems do not provide a feedback loop that technically improves the prompt generation logic and model-interaction pipeline based on user behavior and preferences. Even if users correct or refine recommended measures, such corrections are often logged in an ad-hoc format and are not leveraged to reconfigure the processor's subsequent generation of prompts or its selection of model outputs. This results in repeated generation of unsuitable content, wasted computational cycles, and an inability of the system to converge toward more efficient and accurate interactions with the generative model over time.

Fifth, while some systems attempt to incorporate user sentiment or satisfaction, they often do so only at a user-interface level without integrating emotion information into the core decision logic of the processor. As a consequence, the processor cannot technically optimize its generation of prompts and measures based on systematic patterns in user emotional responses, such as frustration with overly complex instructions or confusion about ambiguous outputs. This lack of integration prevents the system from improving its internal processing flow to reduce error rates and user-induced rework.

Accordingly, there is a need for a technical solution that enables the processor to: (i) structurally preprocess legal revision information for use by a generative model, (ii) generate and adapt prompt sentences in a data-driven manner, (iii) map model outputs to structured internal rule records using similarity computations, (iv) automatically generate stepwise improvement measures and countermeasures as structured data, and (v) update its own prompt-generation and rule-generation logic based on user implementation feedback and emotion information. Such a solution would improve the functioning of the computer system itself by reducing redundant computation, increasing the reliability and accuracy of model-assisted impact detection, and enabling scalable, low-latency generation of compliance measures in response to frequent legal system revisions.

The specific processing by the specific processing unit 290 of the data processing device 12 in Application Example 1 is realized by the following means.

The present invention provides a server comprising a processor configured to acquire information on a legal system revision from an external information source; perform character string processing and natural language processing on the acquired information to structure the information as structured data; generate, based on the structured data, a first prompt sentence that instructs a generative information processing model to identify an impact of the legal system revision on internal business rules of an organization; input the first prompt sentence into the generative information processing model and receive, from the generative information processing model, output text indicating candidates of business rules affected by the legal system revision; transform the output text into candidate entries, and associate the candidate entries with a list of business rules stored in a storage device by using semantic vector similarity calculation or character string matching to specify business rules affected by the legal system revision; generate, based on the specified business rules and the information on the legal system revision, a second prompt sentence that instructs the generative information processing model to generate concrete improvement measures and countermeasures as stepwise procedures for each of the specified business rules; input the second prompt sentence into the generative information processing model and automatically generate, from output of the generative information processing model, the improvement measures and the countermeasures as structured action data; format the structured action data as notification information in a format adapted for display and execution on a user terminal, and transmit the notification information to the user terminal; receive, from the user terminal, an implementation status and a modification instruction corresponding to at least one of the improvement measures and the countermeasures, record the implementation status and the modification instruction in association with the corresponding improvement measures and countermeasures, and update at least one of contents of the first prompt sentence, contents of the second prompt sentence, and generation rules of the improvement measures and the countermeasures based on the recorded implementation status and modification instruction; and use an emotion processing function to collect emotion information of a user from the user terminal, analyze the emotion information in association with the information on the legal system revision and the improvement measures, and adjust at least one of prompt-generation parameters and selection criteria for model outputs based on a result of the analysis. This enables the server to technically improve the processing pipeline for legal revision analysis by automatically structuring legal texts, adaptively generating and refining prompt sentences, efficiently mapping model outputs to stored business rules, and continuously optimizing generation of stepwise improvement measures and countermeasures based on user behavior and emotion information, thereby enhancing accuracy, scalability, and computational efficiency of compliance-related information processing.

The term “legal system revision” refers to a change, amendment, repeal, or enactment of a law, regulation, rule, guideline, or other normative legal instrument issued by a public authority, including associated information such as effective dates and scope of application.

The term “external information source” refers to an information providing entity or system, such as a remote server, database, or network service, from which legal system revision information is obtained via a communication network.

The term “structured data” refers to data that has been organized into a predefined schema or format, such as records, fields, or key-value pairs, enabling programmatic access, querying, and processing by a computer system.

The term “character string processing” refers to computational operations performed on textual data, including at least one of tokenization, normalization, cleaning, segmentation, or pattern detection, for preparing the textual data for further analysis.

The term “natural language processing” refers to a class of computational techniques that analyze and manipulate human language text, including at least one of morphological analysis, syntactic analysis, semantic analysis, entity recognition, or text classification.

The term “generative information processing model” refers to a machine learning model that receives input data and generates new textual or symbolic output, including but not limited to a generative language model or a sequence-to-sequence neural network.

The term “prompt sentence” refers to a text string or set of text strings provided as input to a generative information processing model, the text string or set of text strings specifying at least a task to be performed by the model and contextual information to guide generation of the model output.

The term “internal business rules” refers to policies, procedures, standards, or other rule sets defined within an organization for governing its operations, compliance activities, or decision-making processes.

The term “candidate of business rule” refers to a tentative identification of an internal business rule that may be affected by a legal system revision, the tentative identification being derived from an output of a generative information processing model prior to final confirmation or mapping to a stored record.

The term “storage device” refers to a hardware or virtual component capable of retaining data, including at least one of a magnetic disk, a solid-state drive, a memory device, or a network-accessible storage resource.

The term “semantic vector similarity calculation” refers to a computation that measures similarity between pieces of text by representing the pieces of text as numerical vectors, such as embedding vectors, and applying a similarity metric, such as cosine similarity or distance-based comparison.

The term “character string matching” refers to a comparison process that determines correspondence or similarity between two or more text sequences, including exact matching, partial matching, or pattern-based matching.

The term “improvement measure” refers to an operation, modification, or change to an internal business rule or associated process that is intended to achieve or maintain compliance with a legal system revision.

The term “countermeasure” refers to an action or set of actions for mitigating or preventing negative effects of a legal system revision on an organization's operations, including changes to policies, processes, or system configurations.

The term “stepwise procedure” refers to a series of ordered steps or actions expressed in a structured manner, such as numbered or sequenced instructions, that describe how to implement an improvement measure or countermeasure.

The term “structured action data” refers to data representing improvement measures or countermeasures in a machine-processable format, including identifiers, descriptions, priorities, and deadlines associated with each action.

The term “notification information” refers to data formatted for presentation to a user, the data indicating at least an affected internal business rule, an impact description, and one or more improvement measures or countermeasures.

The term “user terminal” refers to an electronic apparatus operated by a user, such as a computing device, communication device, or display device, that is capable of receiving notification information from a server and transmitting user input to the server.

The term “implementation status” refers to information indicating a progress state of an improvement measure or countermeasure, including at least one of not started, in progress, completed, or deferred.

The term “modification instruction” refers to user-provided information that changes, refines, or supplements at least a part of a generated improvement measure or countermeasure, such as editing content, adjusting scope, or altering timing.

The term “generation rules” refers to parameters, templates, or algorithms used by the processor to construct prompt sentences or to post-process outputs of a generative information processing model into structured action data.

The term “feedback information” refers to information received from a user or user terminal that reflects user responses to generated outputs, including implementation status, modification instructions, evaluations, or comments.

The term “emotion processing function” refers to a software-implemented or hardware-implemented component configured to acquire, detect, or infer emotional states of a user based on input signals, such as textual input, voice, facial expression, or interaction patterns.

The term “emotion information” refers to data representing an estimated or detected emotional state of a user, such as satisfaction, dissatisfaction, confusion, or confidence, associated with a particular interaction or content.

The term “prompt-generation parameter” refers to a variable or configuration value that influences how a prompt sentence is constructed, including at least one of an instruction phrase, level of detail, output format specification, or inclusion of examples.

The term “selection criteria for model outputs” refers to conditions or metrics used to choose, filter, or rank one or more outputs generated by a generative information processing model, such as similarity thresholds, confidence scores, or predefined patterns.

The term “discrimination parameter” refers to a parameter of a classification or decision model used to determine whether a given business operation or business rule is related to a legal system revision.

The term “business operation” refers to an activity, task, or process performed within an organization as part of its functional workflow, including operations related to compliance, data handling, finance, human resources, or manufacturing.

In one embodiment, a server includes a processor, a memory, a storage device, and a network interface, and executes a compliance support program on an operating system such as a general-purpose server operating system. The server is connected via a communication network to one or more user terminals, such as a smartphone, a tablet, a notebook computer, or a head-mounted display device. The server and the terminals exchange data using transport protocols such as HTTPS over TCP/IP.

The server acquires legal system revision information from an external information source. The server uses a communication library such as a HTTP client library on the server operating system to send a request to a remote service that provides legal data. The external information source may provide responses in structured formats such as JSON or XML. The server stores the received raw legal text and associated metadata (for example, law identifier, article numbers, enforcement dates) in a relational storage device, such as a database system implemented by a general-purpose relational database engine.

The server preprocesses the acquired legal text in order to transform unstructured text into structured data suitable for further computational analysis. The server loads the text from the storage device into main memory and applies character string processing and natural language processing. The server uses a text processing library, such as a tokenization and normalization library, to remove markup, standardize encoding, and segment the text into sentences and clauses. The server uses a natural language processing toolkit, such as a part-of-speech tagger and a syntactic parser, to annotate each sentence with linguistic features. The server stores the results in a data structure in memory, for example, a hierarchical tree or graph in which nodes correspond to articles, sections, and clauses, and in which each node is associated with attributes such as text content, citation markers, and detected entities. The server converts the processed text into embedding vectors in order to capture semantic relationships in a machine-tractable numeric representation. The server loads a neural network model, such as a transformer-based encoder, from a model storage area into memory. The neural network may include multiple self-attention layers, feed-forward layers, and layer normalization components. The server inputs each clause-level text segment into the encoder and obtains a fixed-length embedding vector from a designated output layer, such as a pooled output token or an averaged token representation. The server stores these embedding vectors in the storage device in association with the corresponding text segments. This embedding-based representation enables efficient similarity computation when mapping between legal text and internal business rules.

The server maintains an internal repository of business rules in the storage device. Each business rule record includes at least an identifier, a title, a description, and references to associated processes or systems. The server precomputes and stores embedding vectors for the text fields of each business rule using the same or a compatible encoder model. By using a shared embedding space, the server enables high-precision similarity search between legal clauses and internal business rules, which would not be achievable with simple keyword matching alone.

The server constructs a first prompt sentence for a generative AI model to identify candidate business rules affected by a given legal system revision. The server assembles a text string that includes (i) a role instruction, (ii) a description of the task, and (iii) selected legal clauses relevant to the revision. For example, the server may construct the following prompt sentence:

“You are a corporate compliance assistant. Analyze the following revised law text and identify all internal business policies that are likely impacted. For each policy, provide the policy name, a short impact summary, and the reason why the law affects it. Revised law text: [insert selected clauses].”

The server ensures that the prompt sentence respects the input token capacity of the generative AI model by using summarization or clause selection. The server may use the previously computed embedding vectors to select only those clauses most likely to affect the domain of interest, thereby reducing the size of the input and improving computational efficiency.

The server sends the first prompt sentence to a generative AI model. The generative AI model may be implemented as a transformer-based language model executing on an accelerator, such as a graphics processing unit or a specialized inference processor. The server accesses the model via a model inference API and transmits the prompt sentence as input. The model processes the tokenized input through multiple attention layers, each computing attention weights over all tokens, and propagates the representation through feed-forward sublayers with non-linear activation functions. From the final layer, the model samples output tokens according to a probability distribution regulated by a temperature parameter or similar control variable. The model outputs a generated text that includes candidate business policy names and impact descriptions.

The server transforms the generated text from the generative AI model output into structured candidate entries. The server applies pattern recognition logic, such as regular expression patterns or sequence labeling, to identify boundaries of each candidate business policy and to extract subfields such as a policy label, an impact summary, and a reason. The server then uses the previously computed embedding vectors for policy descriptions in the internal repository and computes semantic vector similarity scores between each generated candidate description and each stored business rule embedding. The server may use cosine similarity or another distance metric and may apply an approximate nearest neighbor search algorithm to reduce computational load when the number of rules is large. The server selects, for each candidate, the business rule record whose similarity score exceeds a predefined threshold, thereby establishing an association between the generated candidate and a concrete internal business rule record.

The server generates a second prompt sentence to request concrete improvement measures and countermeasures for the specified internal business rules. The server constructs a text string that includes (i) a summary of the legal revision, (ii) an enumerated list of affected business rules with identifiers and titles, and (iii) explicit instructions regarding the desired output format. For example, the server may construct a prompt sentence such as:
“Based on this legal revision summary and the list of impacted internal policies with IDs and titles, propose concrete, step-by-step countermeasures for each policy. Include specific changes to policy wording, process adjustments, and any system configuration updates that are necessary to comply with the new law. Legal revision summary: [insert summary]. Impacted policies: [ID1—title1; ID2—title2; . . . ].”

The server inputs the second prompt sentence into the same generative AI model, or an alternative generative model specialized for procedural generation, using the model inference API. The model generates text that includes stepwise procedures, such as numbered lists of actions, for each affected business rule. The server parses this generated text into a structured action data format, for example, a table in which each row includes a policy identifier, an action description, a priority, and an optional deadline.

The server formats the structured action data as notification information for display on a user terminal. The server encapsulates the data in a layout specification, such as a set of fields for a graphical user interface: a summary section, a list of impacted policies, and expandable sections for each stepwise procedure. The server transmits this notification information to the user terminal via the network interface.

The terminal receives the notification information and stores it in a local memory area managed by an application program. The terminal uses a user interface framework, such as a graphical toolkit or an augmented reality rendering library, to display the notification to the user. The terminal may render a list of impacted policies with icons indicating priority and implementation status, and may enable the user to open detailed views showing numbered steps for each improvement measure and countermeasure.

The user reviews the displayed information and interacts with the terminal to indicate an implementation status or modification instruction. The user may, for example, mark a step as completed, change a suggested retention period, or add a comment explaining a local constraint. The terminal collects this interaction data as structured feedback information and transmits it back to the server through a secure communication channel.

The server receives the feedback information and updates records associated with the corresponding improvement measures and countermeasures in the storage device. The server maintains, for each action, fields such as current status, time stamps of updates, and a log of user modifications. The server analyzes this accumulated feedback using data processing tools such as statistical aggregations or clustering algorithms to detect patterns such as frequently modified action types or recurrent misunderstandings in generated instructions. The server additionally collects emotion information from the user terminal. The terminal may, for example, provide user assessment inputs such as rating sliders or short textual comments that reflect user frustration, clarity, or satisfaction. The server processes this emotion information using an emotion processing function. The server may apply a sentiment analysis model, such as a neural network classifier trained on labeled emotional text, to convert raw input into discrete emotional categories or continuous sentiment scores. The server associates these emotion values with specific prompt configurations and model outputs. By correlating emotion patterns with properties of generated content (for instance, length, technical complexity, or structure), the server identifies which prompt-generation parameters lead to more comprehensible and acceptable outputs.

The server uses the feedback information and the emotion information to adapt prompt-generation rules and selection criteria for model outputs. The server may implement a learning algorithm, such as a gradient-based optimization or a reinforcement learning policy, that updates prompt templates and model parameters. For example, if the server detects that certain detailed instructions consistently receive negative emotional responses, the server may adjust prompt-generation parameters to request shorter, more structured responses, or to include additional context examples. The server may also adjust the similarity thresholds used in mapping generated candidates to stored business rules when frequent correction patterns indicate systematic over-assignment or under-assignment.

In one embodiment, the server employs a separate training process to refine the generative AI model or associated classifier models. The server stores training data pairs consisting of input prompts, legal texts, user feedback, and corrected outputs. The server uses a supervised learning procedure in which the model's predicted outputs are compared with target outputs prepared from user-corrected actions. The server computes an error value using a loss function, such as cross-entropy between predicted token distributions and target tokens, and updates the model weights by backpropagating gradients through the transformer layers and applying an optimization algorithm such as stochastic gradient descent or adaptive moment estimation. The server can periodically fine-tune the model using this data so that future inferences better match the organization's internal rule structure and user preferences. By structuring the legal revision information as embedding vectors and by leveraging similarity computation in the embedding space, the server reduces reliance on exhaustive keyword search and rule-based parsing. This structured representation enables the server to perform approximate nearest neighbor queries that are sub-linear in the number of stored business rules, thereby improving retrieval speed when the internal repository becomes large. Furthermore, by adaptively generating prompt sentences based on the structured data, the server reduces the number of inference calls required to obtain usable outputs, thereby lowering computational load on the processing hardware.

The server's integration of user feedback and emotion information into the prompt-generation and selection logic constitutes an improvement to computer technology beyond mere automation of human reading and drafting. The server modifies its internal data structures representing prompts, similarity thresholds, and selection strategies based on statistical analysis of feedback and emotion signals, which causes subsequent inferences to converge more quickly to high-quality outputs and reduces the need for repeated re-generation. This improves overall system latency and reduces network traffic between the server and the model-execution environment, resulting in lower communication load. Additionally, because the server automatically transforms unstructured model output into structured action data with explicit identifiers and fields, the system improves data management by enabling indexed retrieval, auditing, and analytics on generated measures.

In an alternative embodiment, the server uses a different encoder model for generating embeddings, such as a convolutional neural network applied to character sequences or a recurrent neural network applied to word sequences. The server may also employ different similarity measures, such as Euclidean distance or Mahalanobis distance, and different approximate search structures, such as locality-sensitive hashing or tree-based indices, to balance accuracy and processing time. In another embodiment, the server uses an ensemble of generative models and selects an output based on selection criteria that consider both semantic consistency with stored rules and historical emotion responses from users. In yet another embodiment, the terminal is implemented as an augmented reality device that overlays generated stepwise procedures onto real-world scenes, such as a production line or a data center rack. The terminal receives notification information that includes location tags or system identifiers, and instructs the user where in the physical environment to apply each action. The server's conversion of legal revisions into spatially annotated action data thereby directly controls the behavior of technical equipment, such as storage systems or network devices, when the user executes configuration changes according to the server's structured guidance.

Through these embodiments, the server and the terminal cooperate to provide a technical system in which legal system revision information is transformed into structured, actionable data via specific neural network architectures, similarity-based mapping, adaptive prompt generation, and feedback-based refinement. This arrangement improves processing speed and accuracy for detecting affected internal business rules, reduces computational and communication overhead in generating countermeasures, and enhances data management of compliance actions, thereby achieving improvements in computer technology rather than a mere automation of human cognitive tasks.

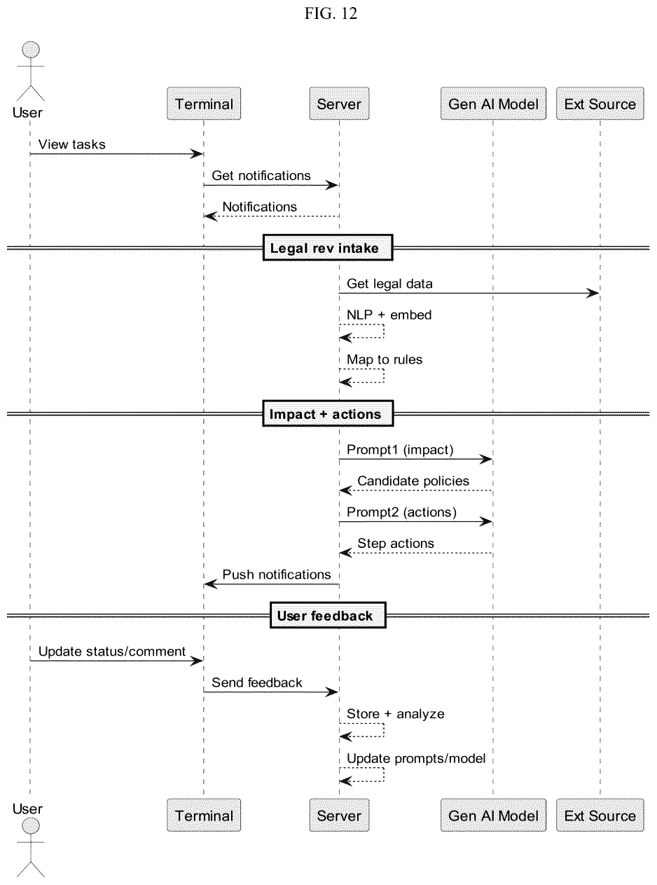

The following describes the processing flow using FIG. 12.

### Step 1:

The server acquires legal system revision information from an external information source. The input is a request parameter set including at least a jurisdiction identifier, a time range, and a law category. The server uses a HTTP client library to send a request over HTTPS to an external legal data service and receives a response in JSON or XML format. The server parses the response, extracts law identifiers, article texts, and enforcement dates, and writes the raw legal text and metadata as records into a legal_revision table in a database. The output is a set of stored legal revision records addressable by a revision identifier.

### Step 2:

The server preprocesses the stored legal text to generate structured legal clauses. The input is a batch of raw legal revision records read from the database. The server loads the text into memory and performs character string processing, including normalization of character encoding, removal of markup tags, and segmentation into paragraphs. The server then applies natural language processing, such as sentence splitting and clause detection, to divide each article into clause-level units. The server builds a hierarchical data structure in which each clause is linked to an article number and a section heading, and stores these clauses into a legal_clause table with fields for revision_id, article_id, clause_id, and clause_text. The output is a set of clause records with normalized and segmented text.

### Step 3:

The server generates embedding vectors for legal clauses. The input is the clause_text field of each legal_clause record. The server loads a transformer-based encoder model into memory and converts each clause_text into tokens. The server feeds the tokens through multiple attention and feed-forward layers of the encoder to obtain a fixed-length vector representation from a designated output layer. The server writes the resulting numeric vectors into an embedding_legal_clause table or a vector field associated with each clause_id. The output is a set of embedding vectors that numerically represent the semantics of each legal clause.

### Step 4:

The server prepares an internal repository of business rules and their embeddings. The input is the existing business_rule records stored in a business_rule table, each including rule_id, rule_title, and rule_description. The server concatenates rule_title and rule_description to form rule_text and feeds this text into the same encoder model used for the legal clauses. The server obtains an embedding vector for each business rule and stores it in an embedding_business_rule table linked by rule_id. The output is a set of business rule embeddings that share the same vector space as the legal clause embeddings.

### Step 5:

The server selects relevant legal clauses for prompt construction. The input is a target legal_revision identifier and a set of embedding vectors for all clauses associated with that revision. The server computes a relevance score for each clause by comparing its embedding vector with a domain anchor vector or previously defined reference embeddings, using a similarity metric such as cosine similarity. The server sorts the clauses by score and selects the top-N clauses that best represent the revision. The output is an ordered list of clause_text entries that will be used in a prompt sentence.

### Step 6:

The server constructs a first prompt sentence for impact detection. The input is the ordered list of selected clause_text entries and a prompt template. The server concatenates a role instruction, a task description, and the selected clauses into a single text string, inserting separators between clauses. The server checks the total token length using a tokenizer for the generative AI model and, if necessary, truncates or summarizes low-priority clauses to remain within a model-specific limit. The output is a first prompt sentence that instructs the generative AI model to identify impacted internal business rules.

### Step 7:

The server sends the first prompt sentence to a generative AI model and receives candidate business policy descriptions. The input is the first prompt sentence. The server creates a request payload containing the prompt and model configuration parameters such as maximum output length and temperature, and transmits the payload to a model inference endpoint over HTTPS. The model processes the prompt and returns a generated text that includes names or descriptions of potentially impacted internal policies. The server parses the response payload and extracts the generated text. The output is a raw model-generated text passage describing candidate business policies and their impacts.

### Step 8:

The server parses and structures the generated candidate business policies. The input is the raw model-generated text. The server applies pattern-based parsing, such as detecting numbered lists or bullet markers, to segment the text into candidate units. For each unit, the server extracts a candidate policy label, an impact summary, and a reason field using regular expressions or a sequence labeling model. The server stores these fields in a candidate_policy table keyed by candidate_id. The output is a structured set of candidate policy entries.

### Step 9:

The server maps candidate policy entries to stored business rules using vector similarity. The input is the candidate_policy entries and the embedding vectors stored in embedding_business_rule. The server generates an embedding vector for each candidate impact description using the encoder model and then computes similarity scores between this vector and each rule embedding. To reduce computational cost, the server may use an approximate nearest neighbor index over the business rule embeddings. The server selects, for each candidate, the rule_id with the highest similarity above a threshold and records the mapping in a mapping_candidate_to_rule table. The output is a set of confirmed impacted business rule identifiers associated with each candidate policy.

### Step 10:

The server generates a second prompt sentence for improvement measures and countermeasures. The input is the set of confirmed impacted business rule identifiers and the legal revision summary. The server retrieves rule titles and short descriptions from the business_rule table and composes an enumerated list of impacted rules. The server then combines a task instruction, the legal revision summary, and the rule list into a structured text string. The server specifies in the text that the output should be a step-by-step list of actions for each rule. The output is a second prompt sentence that instructs the generative AI model to produce concrete, ordered measures.

### Step 11:

The server sends the second prompt sentence to the generative AI model and receives stepwise procedures. The input is the second prompt sentence. The server transmits the prompt to the generative AI model as in Step 7 and receives generated text containing numbered actions for each impacted rule. The server parses the response to identify action blocks per rule, using rule identifiers and numbering patterns. The output is a raw generated text parsed into rule-wise step lists.

### Step 12:

The server converts the generated stepwise procedures into structured action data. The input is the parsed rule-wise step lists. The server iterates over each step and assigns fields such as action_id, rule_id, action_order, action_description, and optional priority or target date. The server stores these records in an action_item table. The server may also normalize terminology by mapping phrases to standardized internal field names using a dictionary or synonym table. The output is a structured action item dataset representing improvement measures and countermeasures.

### Step 13:

The server formats the structured action data as notification information. The input is the action item dataset and associated business_rule and legal_revision records. The server constructs a notification structure that includes a summary of the legal revision, a list of impacted rules, and for each rule, a nested list of action_item entries. The server then serializes this structure into a transport format, such as JSON, with fields suited to a user interface, including titles, short descriptions, and flags for implementation status. The output is a notification payload ready for transmission to user terminals.

### Step 14:

The server transmits notification information to the terminal. The input is the notification payload and a list of target user identifiers associated with impacted rules. The server consults a user-rule mapping table to determine which users should receive which notifications and then sends push messages or API responses via a messaging service or direct HTTPS calls to the terminals. The server records message identifiers and delivery timestamps in a notification_log table. The output is a set of delivered notifications in the terminals' local storage.

### Step 15:

The terminal receives and stores the notification payload. The input is the notification message delivered from the server. The terminal's application listens for incoming messages using a push service or polling API, parses the JSON payload, and writes the notification content into a local database or memory cache, associating it with a notification_id and user_id. The output is a locally stored notification record accessible to the terminal's user interface module.

### Step 16:

The terminal displays the impacted rules and stepwise actions to the user. The input is the locally stored notification record. The terminal uses a user interface framework to render a screen or view that shows the legal revision summary, a list of impacted business rules, and for each rule, an expandable list of numbered action steps. The terminal may include visual indicators such as checkboxes for implementation status and colored icons for priority. The output is a human-readable presentation of the server-generated measures.

### Step 17:

The user reviews the displayed information and inputs implementation status or modifications. The input is the displayed screen and the stepwise actions. The user interacts with the terminal by touching the screen, clicking, or using other input methods to mark steps as “in progress” or “completed,” edit action descriptions, or add comments. The terminal converts these interactions into structured feedback, including updated status values and modification texts. The output is a set of user-generated feedback entries in the terminal's memory.

### Step 18:

The terminal transmits user feedback and modifications to the server. The input is the feedback entries stored locally. The terminal packages the feedback as a request payload containing notification_id, rule_id, action_id, new_status, and user_comment, and sends it to the server via HTTPS. The terminal waits for a confirmation from the server and may update the local status to reflect that the feedback was successfully synchronized. The output is a feedback payload delivered to the server.

### Step 19:

The server stores and analyzes the feedback information. The input is the feedback payloads received from multiple terminals. The server writes the new status and user comments into feedback and action_item tables, updating the corresponding records. The server then aggregates feedback across users and revisions, computing statistics such as completion rates per rule, frequency of modifications per action type, and typical changes to suggested values. The output is an updated database of actions with associated feedback metrics.

### Step 20:

The server acquires and processes emotion information from the terminal. The input is user-provided emotion-related data, such as ratings or textual comments about clarity and usefulness. The server feeds textual comments into a sentiment analysis classifier and obtains emotion labels or scores. The server links these emotion scores to specific prompt configurations, legal revisions, and action_item records. The output is a dataset of emotion annotations associated with generated content and prompt parameters.

### Step 21:

The server updates prompt-generation rules and selection criteria based on feedback and emotion information. The input is the aggregated feedback metrics and emotion annotations. The server applies a learning algorithm that adjusts parameters such as desired output length, detail level, and formatting instructions in the prompt templates. The server may also modify similarity thresholds used in mapping candidate policies to business rules when it detects consistent over-linking or under-linking. The server stores the updated prompt-generation parameters and thresholds in a configuration table. The output is a revised configuration that will be used in subsequent executions of Steps 5, 6, 7, 10, and 11.

### Step 22:

The server optionally retrains or fine-tunes associated machine learning models using accumulated interaction data. The input is a training dataset compiled from historical prompts, legal texts, generated outputs, user-corrected actions, and emotion labels. The server runs a training process in which it computes loss values comparing model outputs to user-adjusted targets, backpropagates gradients through the network layers, and updates weights using an optimization algorithm. The server then deploys the updated model to the inference environment. The output is an improved generative AI model or encoder that, when used in earlier steps, produces outputs more closely aligned with the organization's internal business rules and user preferences.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional systems that support compliance with legal or regulatory amendments generally rely on static rule sets or manually crafted templates to analyze amendment texts and to derive corresponding operational measures. Such systems suffer from several technical limitations. First, they treat legal texts as unstructured strings and perform only shallow parsing, which leads to low precision in extracting obligations, prohibitions, thresholds, and penalties, and to poor identification of which internal business processes are actually affected. Second, existing prompt generation for generative AI models, when used, is typically handcrafted or fixed, and is not dynamically adapted based on the structure of the incoming legal text or on prior interaction data. As a result, the quality and relevance of the responses produced by the generative AI model are unstable, and a large amount of human effort is required to review and correct the outputs.

Furthermore, conventional architectures do not maintain a unified, machine-usable representation that ties together the original amendment information, derived legal elements, affected business processes, generated prompt sentences, responses from the generative AI model, and user feedback. Without such a representation, it is difficult to systematically improve the prompt generation logic and business process identification logic over time, and system behavior cannot be effectively optimized based on historical performance. In addition, most existing compliance support systems ignore real-time user emotion information. User interfaces are typically static and do not adjust the manner or level of detail of the generated improvement measures and countermeasures according to the user's emotional state. This can result in cognitive overload, poor usability, and inefficient interaction loops, especially when users are stressed by frequent or complex regulatory changes.

Accordingly, there is a need for a computer-implemented technique that: (i) performs structured, fine-grained natural language processing on legal or regulatory amendment information to extract key legal elements and to identify affected business processes; (ii) automatically constructs optimized prompt sentences for a generative AI model based on such structured information; (iii) uses a machine learning model to improve the identification of affected business processes; (iv) maintains and exploits a persistent association between amendment information, prompt sentences, model responses, and user feedback for continuous refinement; and (v) incorporates emotion recognition data to adapt the content and presentation manner of generated improvement measures and countermeasures. The technical problem is to improve the overall performance, reliability, and usability of computer systems that generate and present compliance-related operational guidance by integrating structured text analysis, adaptive prompt engineering, and feedback-driven model behavior into a unified processing flow.

The specific processing by the specific processing unit 290 of the data processing device 12 in Example 2 is realized by the following means.

The present invention provides a server comprising a processor configured to acquire information relating to a legal or regulatory amendment from at least one external information source and from a terminal, preprocess the information relating to the legal or regulatory amendment by using natural language processing so as to perform at least one of character string normalization, word segmentation, sentence boundary detection, and part-of-speech assignment, extract, from the preprocessed information, elements corresponding to at least one of obligations, prohibitions, thresholds, and penalties, generate summary information of the legal or regulatory amendment based on the extracted elements, identify business processes that are affected by the legal or regulatory amendment based on the summary information, construct an instruction sentence for input to a generative AI model by using the summary information of the legal or regulatory amendment and information relating to the affected business processes, generate the instruction sentence as a prompt sentence, input the prompt sentence to the generative AI model, obtain response information relating to improvement measures and countermeasures for the business in accordance with the legal or regulatory amendment from the generative AI model, perform post-processing to convert the response information into structured data, output the post-processed improvement measures and countermeasures to the terminal, acquire emotion data by using an emotion recognition function in order to recognize a user emotion, adjust at least one of content and presentation manner of the improvement measures and the countermeasures based on the emotion data and the response information obtained from the generative AI model, and store, in an associated manner, the acquired information relating to the legal or regulatory amendment, the prompt sentence, the response information, and evaluation information from the user, and update processing for generating the prompt sentence and identifying the affected business processes based on the stored information. This enables a computer system to more accurately and efficiently transform unstructured legal or regulatory amendment information into structured internal representations, to automatically generate optimized prompt sentences for a generative AI model, to improve the relevance and quality of generated improvement measures and countermeasures through machine learning and historical feedback, and to adapt the presentation of such measures and countermeasures in real time based on user emotion, thereby enhancing the technical performance and usability of compliance support processing.

The term “legal or regulatory amendment” refers to a change, addition, deletion, or replacement in a legal norm, including but not limited to statutes, regulations, rules, guidelines, or administrative notices, that affects obligations, prohibitions, thresholds, or penalties applicable to an activity.

The term “external information source” refers to an information providing entity or service outside the system, including but not limited to network-accessible data sources, such as databases, document repositories, or web services, from which legal or regulatory amendment information can be electronically obtained.

The term “terminal” refers to an information processing apparatus operated by a user, including but not limited to a personal computer, a mobile device, or any network-connected client device configured to transmit data to and receive data from the server.

The term “natural language processing” refers to a set of computational techniques for analyzing and transforming human language text, including but not limited to tokenization, sentence segmentation, part-of-speech tagging, syntactic analysis, semantic analysis, and information extraction.

The term “character string normalization” refers to processing for unifying a text representation, including but not limited to conversion of character encodings, standardization of whitespace, conversion between character widths, and normalization of variant characters into canonical forms.

The term “word segmentation” refers to processing for dividing a sequence of characters into word units or tokens, including but not limited to separating words, punctuation marks, and symbols that form the basis for subsequent linguistic analysis.

The term “sentence boundary detection” refers to processing for detecting boundaries between sentences in text, including but not limited to identifying sentence-ending punctuation or using statistical or rule-based methods to determine sentence units.

The term “part-of-speech assignment” refers to processing for assigning a grammatical category, such as noun, verb, adjective, or adverb, to each token in a text, typically based on linguistic rules or machine learning models.

The term “element corresponding to obligations, prohibitions, thresholds, and penalties” refers to a portion of text or a structured representation that expresses a duty to act, a restriction on actions, a quantitative or qualitative limit, or a sanction associated with non-compliance.

The term “summary information of the legal or regulatory amendment” refers to a condensed representation of a legal or regulatory amendment, including extracted key elements, such as main obligations, prohibitions, thresholds, and penalties, formatted in a way that is suitable for machine processing.

The term “business process” refers to an operational procedure or workflow executed within an organization, including but not limited to scheduling, resource management, transaction processing, record keeping, or other structured activities.

The term “affected business processes” refers to business processes in which at least one operational rule, constraint, or parameter is influenced by a legal or regulatory amendment, such that the process may require modification for compliance.

The term “generative AI model” refers to an information processing model based on machine learning that, when provided with input data including a prompt sentence, generates output data such as natural language text representing improvement measures, countermeasures, or other suggested content.

The term “instruction sentence” refers to a natural language text sequence that specifies, for a generative AI model, a generation task, constraints, or output format, and that guides the generative AI model to produce a desired type of response.

The term “prompt sentence” refers to an instruction sentence that is formatted and provided as input to a generative AI model, including descriptions of a legal or regulatory amendment, affected business processes, and desired output characteristics.

The term “response information” refers to information output from a generative AI model in response to a prompt sentence, including but not limited to text describing improvement measures, countermeasures, operational changes, or system modifications.

The term “post-processing” refers to processing that modifies or restructures response information generated by a model, including but not limited to formatting, parsing into structured records, removing redundancy, or classifying content into categories.

The term “structured data” refers to data represented in a predefined format or schema, such as a table, record, or hierarchical data structure, configured to allow programmatic access to individual fields corresponding to improvement measures or countermeasures.

The term “improvement measures and countermeasures” refers to proposed actions, changes, or configurations in business processes, systems, or policies, designed to achieve or maintain compliance with a legal or regulatory amendment.

The term “emotion recognition function” refers to a computational mechanism that estimates a user's emotional state based on input signals, including but not limited to textual input, audio input, image input, physiological data, or interaction patterns.

The term “emotion data” refers to data representing a user's emotional state, including but not limited to categorical labels, numerical scores, or feature vectors, which are derived from the emotion recognition function.

The term “content and presentation manner” refers to both the substantive details of information presented to a user and the way such information is displayed or communicated, including level of detail, ordering, emphasis, layout, and modality.

The term “evaluation information from the user” refers to data that indicates a user's assessment or feedback regarding generated improvement measures and countermeasures, including but not limited to explicit ratings, acceptance or rejection flags, comments, or selections.

The term “machine learning model” refers to a computational model that is trained on data to perform a prediction or classification task, such as mapping textual features of a legal or regulatory amendment to one or more business process classifications.

The term “business process classification” refers to a label or category that represents a type of business process, such as compliance management, scheduling, accounting, or data handling, assigned for the purpose of grouping or identifying affected processes.

The term “predefined business processes” refers to business processes that are registered or stored in advance in a data repository of the system, each having at least an identifier and associated descriptive information.

The term “internal representation” refers to a data structure maintained within the system that aggregates information such as summary information of a legal or regulatory amendment, affected business processes, and business environment information, in a form suitable for algorithmic processing.

The term “business environment information” refers to information describing the operational context of an organization, including but not limited to industry type, organizational structure, system configuration, workforce characteristics, and constraints specified by a user.

The term “template information” refers to pre-defined data structures or patterns that describe how to combine internal representation elements into a prompt sentence, including definition of instruction content, required fields, and output formatting constraints for a generative AI model.

In one embodiment, a server cooperates with at least one terminal operated by a user to implement the claimed system. The server includes at least one processor, a main memory, a non-volatile storage device, and a network interface. The processor may be implemented by a general-purpose central processing unit such as an x86-compatible processor or a reduced instruction set processor. The server may further include a graphics processing unit or tensor processing unit when large-scale model inference is required. The memory stores executable program modules that cause the processor to execute the functions described below. The storage device, such as a magnetic disk drive or a solid-state drive, stores legal or regulatory amendment data, intermediate analysis results, prompt sentences, and responses generated by a generative AI model.

The terminal includes a processor, a display, an input device, a memory, and a communication module. The terminal may be implemented as a desktop computer, a notebook computer, a tablet device, or a smartphone. The terminal executes application software such as a web browser or a native client application. The terminal displays user interfaces that allow the user to input legal or regulatory amendment information and to review improvement measures and countermeasures output by the server.

The server uses software components that include a web application framework, a database management system, a natural language processing library, a machine learning framework, and a generative AI inference framework. For example, the server uses a web framework such as a scripting-language-based HTTP framework to receive data from the terminal. The server uses a relational database system such as a structured query language database to store amendment records, analysis results, prompt sentences, and user feedback in tables having defined schemas. The server uses a natural language processing library such as a tokenization and part-of-speech tagging toolkit or a statistical parsing library to perform text analysis. The server uses a machine learning framework such as a tensor-based numerical computation library or a general-purpose machine learning library to implement classifiers and embedding models. The server uses a transformer-based generative model implementation or a remote model inference service to execute a generative AI model.

The server stores amendment data and analysis results in specific data structures. The server stores each legal or regulatory amendment in an amendment record including fields for an amendment identifier, a user identifier, raw text, normalized text, an impact summary, and timestamps. The server stores natural language processing results in a separate record that includes token sequences, sentence boundaries, and part-of-speech tags. The server stores extracted legal elements such as obligations, prohibitions, thresholds, and penalties in element records linked to the amendment identifier. The server stores business process classifications and their confidence scores in another record. The server stores prompt sentences in a prompt record that includes a prompt identifier, an associated amendment identifier, a prompt text field, and model parameter fields. The server stores responses from the generative AI model in a solution record that includes textual output and a structured representation of individual measures.

The server uses multiple software modules to transform unstructured legal or regulatory text into structured internal representations. The server uses a preprocessing module to normalize character encodings, convert variant characters into canonical forms, and remove control characters. The server uses a tokenizer module to divide text into token units and to assign sentence boundaries. The server uses a part-of-speech tagging module to assign grammatical categories to tokens. The server further uses a syntactic parsing module and an information extraction module to detect patterns that correspond to obligations, prohibitions, thresholds, and penalties. For example, the server uses dependency parsing to identify relations between verb tokens and quantifier tokens so that the server can recognize that “must not exceed 40 hours” encodes a threshold of 40 units applied to a time-related quantity.

The server uses a machine learning model to identify affected business processes based on the extracted legal elements and contextual information. The server may implement this model as a neural network classifier that receives as input a feature vector representing the amendment. The feature vector may include term-frequency values of key tokens, positions of detected obligations and thresholds, and embeddings of the amendment text. The server may construct embeddings using a transformer encoder network having multiple self-attention layers, in which the server computes attention weights for each token relative to all other tokens and generates contextualized token vectors. The server aggregates these token vectors using pooling operations to produce a fixed-length representation of the amendment.

The server feeds this representation into a fully connected layer that outputs probability scores for multiple business process classes. Because this classifier uses contextual embeddings rather than simple keyword counting, the server can disambiguate similar terms used in different legal contexts and therefore can assign more accurate business process classifications.

The server uses a prompt generation module to build a prompt sentence for the generative AI model. The server constructs an internal representation that combines the summary of the legal or regulatory amendment, the list of affected business processes and their confidence scores, and business environment information supplied by the user. The server stores this internal representation as a structured object in memory. The server applies this internal representation to template information. The template information defines segments such as an amendment summary segment, an affected processes segment, a role specification segment, and an output format segment. By filling these segments programmatically rather than by static text, the server avoids suboptimal or inconsistent instructions to the generative AI model.

For example, the server may generate the following prompt sentence:

“Legal amendment summary: The new labor law introduces a 40-hour weekly cap on working time and requires higher overtime pay beyond 40 hours. Affected business operations: shift scheduling, attendance management, payroll calculation. Our company operates multiple retail stores with shift-based staff. As a compliance consultant, propose specific operational and system-level measures to ensure compliance with this law. Provide the answer as a numbered list with concrete steps under the headings ‘Shift Scheduling,’ ‘Attendance Management,’ and ‘Payroll.’”

In another example, when the amendment relates to data protection, the server may generate the following prompt sentence:

“The revised data protection regulation requires explicit consent from users before collecting location data and limits data retention to 6 months. Our company provides a mobile delivery application that tracks drivers' locations in real time. Please propose detailed operational and system-level countermeasures to comply with these requirements, including changes to consent user experience, data storage policies, and log retention. Provide the answer in bullet points with separate sections for ‘Application Changes,’ ‘Data Storage,’ and ‘Internal Procedures.’”

The server uses a generative AI model implemented as a transformer-based language model. The server may execute this model locally or may invoke it through a network-accessible inference service. The generative AI model includes multiple attention layers, feedforward layers, and layer normalization components. The server provides the prompt sentence as tokenized input embeddings and receives predicted token sequences as output. The generative AI model has been previously trained on text data including legal, technical, and operational documents. During training, the server or a training environment minimizes a loss function such as cross-entropy between predicted tokens and ground-truth tokens, and updates model weights using an optimization algorithm such as stochastic gradient descent with momentum or an adaptive gradient method. The training process includes techniques such as dropout and layer-wise learning rate scheduling to improve generalization.

By using a generative AI model with a transformer architecture, the server obtains coherent and context-sensitive suggestions for improvement measures. The server further constrains the model behavior by specifying output format instructions within the prompt sentence, so that the server can easily parse the response and map individual measures to structured fields. The server uses post-processing modules to detect headings, number lists, and extract sentences representing discrete measures. The server may use regular expression-based parsing or shallow syntactic parsing to divide the response into units. The server then maps each unit into a structured representation including a category field, a description field, and optional priority or cost fields.

The server integrates an emotion recognition function to adapt the content and presentation manner of the measures. The terminal captures interaction signals that may include text-based responses, response times, or explicit emotion ratings from the user. In some embodiments, the terminal further acquires physiological data or facial image data, subject to consent. The terminal transmits these signals to the server. The server uses a lightweight classifier model to map these signals to an emotion label or an emotion score vector. The classifier may be implemented as a small neural network or a support vector machine trained on labeled interaction patterns.

The server adjusts the level of detail and ordering of the generated measures based on the emotion data. For example, when the emotion recognition function indicates a high stress state, the server may filter the measures to present a smaller set of high-impact steps first, thereby reducing cognitive load. When the emotion recognition function indicates a neutral or positive state, the server may present a more detailed and comprehensive list. This adaptation relies on algorithmic rules that map emotion scores and measure complexity metrics to presentation parameters such as the number of displayed items, level of explanatory detail, and emphasis indicators. The server thus does more than simply display generated text; the server computes a mapping that optimizes presentation for the current user state. The server stores a complete history of amendment texts, extracted legal elements, identified business processes, generated prompt sentences, model responses, user evaluations, and emotion data. The server defines relational tables or document-based collections that maintain associations between these objects using identifiers and foreign keys. The server can query this history to perform incremental refinement of the prompt generation and business process classification logic. For instance, the server can train or fine-tune the business process classifier using feedback labels that indicate which processes were actually relevant in practice. The server can also learn correlations between prompt sentence patterns and subsequent user evaluations of response quality. Using this information, the server can adjust template segments, add new constraint phrases, or modify the ordering of information in the prompt sentence.

The server achieves technical improvements in processing efficiency and accuracy by performing structured intermediate representations rather than ad hoc string passing. Because the server represents amendments, legal elements, processes, prompts, and responses as linked records with defined schemas, the server can perform indexed queries in the database, reduce redundant computations, and quickly retrieve similar past cases to inform new prompt construction. The use of contextual embeddings and transformer-based classifiers for business process identification improves classification accuracy compared to keyword-based methods and reduces the number of misdirected queries to the generative AI model. As a result, the server decreases computational load on the generative AI model, because fewer iterations of prompt revision and re-generation are necessary.

The server further improves technical performance by controlling the length and structure of prompt sentences using the internal representation. By selectively including only key legal elements and the highest-confidence business process labels, the server reduces the number of tokens passed to the generative AI model without losing essential context. This reduction in input size leads to lower memory usage and shorter inference time per request in the transformer network, thereby improving throughput and reducing latency. At the same time, the structured representation ensures that necessary context is preserved, which stabilizes model outputs and reduces the need for post-correction.

The server implements non-conventional processing flows that differ from manual work and traditional rule-based systems. The server does not simply mimic an expert reading a law and drafting measures; instead, the server decomposes the task into multiple machine-oriented steps: tokenization, part-of-speech tagging, dependency parsing, extraction of structured elements, embedding-based classification of business processes, programmatic template filling for prompt generation, transformer-based text generation, and structure-aware post-processing. Each step operates on machine-optimized data structures and is designed to feed reliable information into the next step. This division of labor yields a pipeline that is not practicable by human operators in real time and that exhibits computational advantages such as sublinear search in stored histories, vectorized calculations in neural networks, and parallel processing of tokens in attention layers.

The server can be implemented in alternative embodiments. In one embodiment, the server executes all natural language processing and generative AI inference locally using a high-performance computing platform equipped with multiple graphics processing units. In another embodiment, the server offloads the generative AI inference to a remote model inference service while performing all preprocessing, extraction, classification, and prompt generation locally. In yet another embodiment, the server partitions the pipeline so that a first server performs natural language preprocessing and extraction, and a second server specialized in model inference performs prompt-based generation and returns structured responses. These variations demonstrate that the claimed configuration is not tied to a single physical deployment but is instead realized through cooperating computing devices.

The server can also use alternate model architectures for business process identification. In one variant, the server uses a gradient-boosted decision tree model trained on manually engineered features such as counts of legal terms, presence of time-related thresholds, and co-occurrence patterns of domain-specific terms, instead of a transformer-based classifier. In another variant, the server uses a convolutional neural network to extract local n-gram patterns and to feed them into a classification layer. These variants still rely on the same fundamental approach: extraction of structured features from legal text and mapping to predefined business process categories stored in the database.

The terminal interacts with the server using secure communication protocols. The terminal transmits amendment texts and receives improvement measures via encrypted channels. The terminal renders structured responses using graphical user interface elements such as headings, lists, checkboxes, and expandable panels. The terminal allows the user to submit feedback on individual measures, such as marking them as “adopted,” “rejected,” or “needs review.” The terminal transmits these feedback labels to the server, which stores them as user evaluation information associated with each solution record. The feedback data enables the server to train ranking models or rule-based filters that prioritize measures with historically high acceptance rates in similar contexts, thus further improving the practical utility and stability of the system.

By integrating these components—structured natural language analysis, machine-learned business process identification, template-based prompt sentence generation, transformer-based generative AI inference, emotion-aware adaptation, and feedback-driven refinement—the server implements a specific, non-generic improvement to computer processing of legal or regulatory texts. The server achieves quantifiable improvements in classification accuracy, response relevance, latency, and resource utilization, and provides a technical solution for managing complex amendment information in computing environments that cannot be realized by conventional manual procedures or simple automation of human tasks.

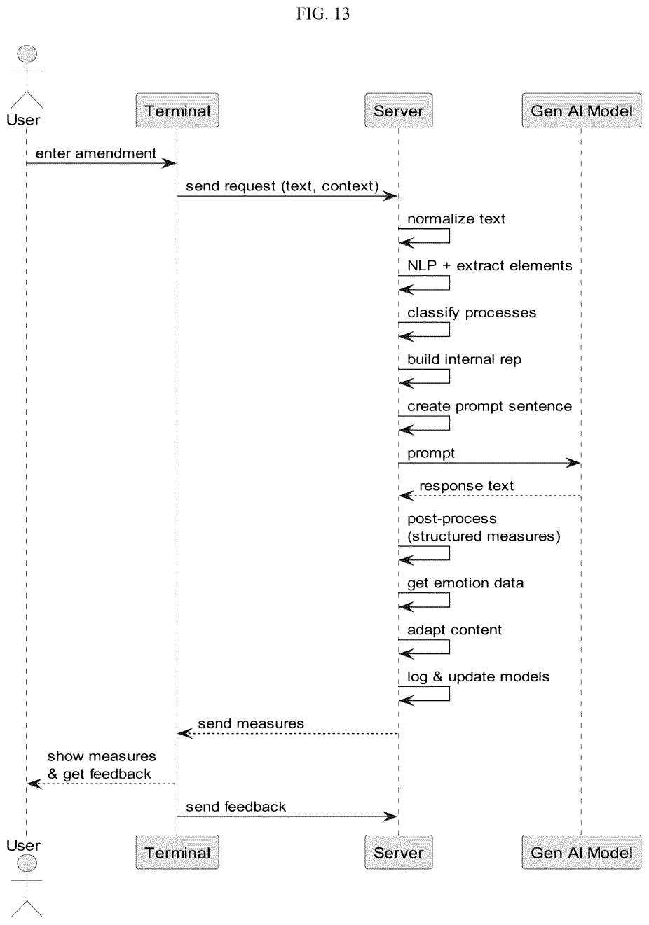

The following describes the processing flow using FIG. 13.

### Step 1:

The user operates the terminal to input information relating to a legal or regulatory amendment.

The terminal displays an input screen including at least a text field for amendment content and optional fields for business environment information.

Input: raw amendment text and optional business environment text entered by the user. The terminal converts the user input into a structured request object, for example by assigning keys such as “amendment_text” and “business_context,” and serializes the object into a message format.

Output: a structured request message containing the amendment text and business environment information, ready to be transmitted to the server.

### Step 2:

The terminal transmits the structured request message to the server via a communication network.

Input: the structured request message generated in Step 1.

The terminal opens a secure communication channel, encapsulates the message in a network protocol packet, and sends the packet to a predefined endpoint associated with the server.

Output: a network request containing the structured request message delivered toward the server.

### Step 3:

The server receives the network request and parses the structured request message.

Input: the network request from the terminal.

The server validates the message format, checks required fields such as the amendment text, and extracts data fields into internal variables or data structures.

Output: extracted amendment text and extracted business environment information stored in server memory.

### Step 4:

The server normalizes the amendment text using a text preprocessing module.

Input: extracted amendment text from Step 3.

The server applies character string normalization, including conversion of encoding to a standard format, removal of control characters, unification of whitespace, and canonicalization of variant characters. The server performs simple pattern-based replacements to standardize date expressions and numeric expressions.

Output: normalized amendment text stored as a cleaned string.

### Step 5:

The server performs natural language processing on the normalized amendment text.

Input: normalized amendment text from Step 4.

The server tokenizes the text into tokens, identifies sentence boundaries, and assigns part-of-speech tags to each token using an NLP library. The server optionally performs dependency parsing to determine syntactic relations between tokens.

Output: a token sequence with sentence boundary indices and part-of-speech tags, and optionally dependency relations, stored in a structured representation.

### Step 6:

The server extracts legal elements such as obligations, prohibitions, thresholds, and penalties from the structured representation of the amendment text.

Input: the token sequence and associated annotations from Step 5.

The server applies pattern-matching rules and/or a trained extraction model to detect phrases that match legal element patterns. For example, the server looks for modal verbs combined with negation and numeric expressions to identify thresholds, and for verbs associated with sanctions to identify penalties. The server maps each detected phrase to an element type and stores attributes such as the numeric value for thresholds.

Output: a collection of extracted legal elements, each tagged with a type (obligation, prohibition, threshold, or penalty) and associated attributes.

### Step 7:

The server generates summary information of the legal or regulatory amendment based on the extracted legal elements and the original text.

Input: the collection of legal elements from Step 6 and the normalized amendment text from

### Step 4

The server selects key elements, removes duplicates, and assembles a concise description by concatenating or paraphrasing the most important obligations, prohibitions, thresholds, and penalties. The server may weight elements by importance using heuristic rules or learned scores, and may limit the length of the summary.

Output: a textual amendment summary that captures the main legal changes in a compact form.

### Step 8:

The server computes a feature representation of the amendment for business process classification.

Input: the normalized amendment text, the token annotations, and the extracted legal elements from Steps 4 to 6.

The server generates a feature vector by combining numerical representations of tokens (such as embeddings), indicators of detected element types, and statistics such as the count and positions of thresholds or penalties. The server may use a transformer encoder or another embedding technique to produce a fixed-length numeric vector.

Output: a feature vector representing the amendment in a form suitable for machine learning classification.

### Step 9:

The server identifies affected business processes by applying a machine learning model to the feature vector.

Input: the feature vector from Step 8.

The server feeds the feature vector into a trained classifier, such as a neural network or a decision-tree-based model, which computes classification scores for multiple business process categories. The server interprets the scores as probabilities or confidence values, ranks the categories, and selects those above a predetermined threshold.

Output: a set of affected business process labels with associated confidence scores.

### Step 10:

The server constructs an internal representation that aggregates amendment summary, legal elements, affected business processes, and business environment information.

Input: the amendment summary from Step 7, the legal elements from Step 6, the affected business process labels from Step 9, and the business environment information from Step 3.

The server creates a structured object containing fields for summary text, element list, process list with confidences, and environment descriptors. The server arranges the data in a hierarchy or a key-value structure optimized for subsequent template application. Output: an internal representation object summarizing the legal amendment and its operational context.

### Step 11:

The server generates a prompt sentence for a generative AI model by applying the internal representation to template information.

Input: the internal representation from Step 10 and stored template information defining sections and placeholders.

The server selects a template appropriate to the type of amendment or business context, replaces placeholders with values from the internal representation, and concatenates template sections to form a continuous instruction text. The server may adjust wording and detail-level based on the confidence scores for affected processes.

Output: a prompt sentence that instructs the generative AI model to generate improvement measures and countermeasures in a specified format.

### Step 12:

The server prepares and sends an inference request to the generative AI model.

Input: the prompt sentence from Step 11 and configuration parameters for model inference. The server tokenizes the prompt sentence, converts tokens to embeddings, and if using a remote model, packages the tokenized input into an inference request. The server transmits the request to the model inference engine via a network interface or passes it to a local model execution module.

Output: an inference request containing the encoded prompt sentence delivered to the generative AI model execution environment.

### Step 13:

The generative AI model processes the encoded prompt sentence and generates response information containing improvement measures and countermeasures.

Input: the encoded prompt sentence from Step 12.

The generative AI model computes attention scores across tokens, propagates activations through multiple transformer layers, and sequentially predicts output tokens according to a learned probability distribution. The model repeats token prediction until an end condition is met, such as reaching a maximum length or emitting an end-of-sequence token.

Output: a sequence of output tokens representing natural language text describing improvement measures and countermeasures, which is returned to the server.

### Step 14:

The server receives the generated token sequence and reconstructs response text.

Input: the output token sequence from Step 13.

The server converts tokens back into characters using a decoding table and merges them into a contiguous text string. The server handles special tokens such as newline or list markers to reconstruct intended formatting.

Output: raw response text representing the generative AI model's proposed improvement measures and countermeasures.

### Step 15:

The server post-processes the raw response text to create structured improvement measures and countermeasures.

Input: the raw response text from Step 14.

The server parses the text to detect headings, numbered lists, and bullet points, using pattern matching and simple syntactic rules. The server extracts each listed item as an individual measure, associates it with a category inferred from its surrounding heading, and optionally assigns attributes such as implementation complexity or affected business process.

Output: a structured collection of improvement measures and countermeasures, each represented as a record with fields for category, description, and optional attributes.

### Step 16:

The server acquires emotion data to recognize the user's emotional state.

Input: interaction data and explicit emotion-related signals received from the terminal, such as user ratings, response times, or other indicators.

The server transforms the interaction data into numerical features and applies an emotion recognition model or rule set to derive an emotion label or score vector.

Output: emotion data representing the user's current emotional state, stored in association with the current session.

### Step 17:

The server adjusts the content and presentation manner of the structured improvement measures and countermeasures based on the emotion data.

Input: the structured measures from Step 15 and the emotion data from Step 16.

The server evaluates the emotion label and selects an adaptation strategy, for example filtering to a smaller number of high-priority measures when stress is high, or expanding with more detailed explanations when the user is calm. The server reorders measures, adjusts explanatory text, and marks recommendations for emphasis according to predefined rules.

Output: an adapted set of improvement measures and countermeasures tailored in content and order to the user's emotional state.

### Step 18:

The server sends the adapted measures and countermeasures to the terminal for display.

Input: the adapted set of measures from Step 17.

The server formats the structured data into a response message, including headings, lists, and metadata, and transmits the message via the communication network.

Output: a response message containing adapted improvement measures and countermeasures delivered to the terminal.

### Step 19:

The terminal receives the response message and renders the adapted measures and countermeasures to the user.

Input: the response message from Step 18.

The terminal parses the message, constructs user interface elements such as section headers and numbered items, and displays them on the screen. The terminal may provide interactive controls for the user to mark measures as adopted, rejected, or to-be-reviewed.

Output: a visual presentation of the improvement measures and countermeasures on the terminal display, and optionally user interaction events captured for feedback.

### Step 20:

The user reviews the presented measures and provides evaluation information through the terminal.

Input: the displayed measures on the terminal screen.

The user selects buttons or input fields to express evaluation, such as approving or rejecting specific measures or adding comments. The terminal aggregates these evaluations into a structured feedback message.

Output: a structured feedback message containing evaluation information for individual measures, sent from the terminal to the server.

### Step 21:

The server stores amendment information, prompt sentence, response information, emotion data, and user evaluation information in persistent storage.

Input: the normalized amendment text, the internal representation, the prompt sentence from Step 11, the structured measures and countermeasures from Step 15, the emotion data from Step 16, and the feedback message from Step 20.

The server inserts or updates records in database tables or document collections, maintaining associations via identifiers and foreign keys. The server indexes key fields such as amendment types, business processes, and user evaluation outcomes to facilitate future queries.

Output: persistent records that link amendment information, generated prompts, model responses, emotion data, and user evaluations for use in subsequent processing.

### Step 22:

The server updates processing logic for prompt generation and business process identification based on stored records.

Input: the historical records stored in Step 21.

The server analyzes the correlations between classification outputs, prompt sentence patterns, response quality indicators, and user evaluations by computing statistics or re-training machine learning models. The server adjusts model parameters, modifies template segments, or updates rule thresholds to improve future identification accuracy and response relevance.

Output: updated model parameters, updated template definitions, and updated rules that refine subsequent processing of legal or regulatory amendments.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional compliance support systems for handling law or regulation revisions typically follow a static, rule-based workflow. Such systems require human experts to manually read legal texts, interpret revision points, map them to internal business processes, and then design countermeasures or improvement plans. This causes several technical problems in computer-based processing.

First, a conventional system lacks a unified, machine-tractable representation of law revision information. Legal texts are ingested as unstructured documents, and the computer generally stores them as raw text without extracting structured revision points or legal requirements. As a result, the system cannot efficiently compute relevance between law revisions and business process data, and must rely on manual analysis. This leads to increased processing latency, low scalability when the volume or frequency of law revisions grows, and an inability to automatically update system behavior in a timely manner.

Second, a conventional system does not incorporate user emotion data into its computational model. Although users may experience stress or frustration during certain workflows affected by legal changes, the system does not acquire and analyze multimodal emotion data such as audio, image, or biometric signals. The system therefore cannot automatically correlate user emotion states with specific tasks or time periods in log data. This results in a technical limitation: the processor cannot prioritize or generate recommendations that simultaneously optimize legal compliance and reduce user stress, and cannot learn from user feedback in a closed-loop, data-driven way.

Third, existing systems that use artificial intelligence or generative models for recommendations often treat prompt construction as a fixed, manually designed artifact. The system typically sends a static prompt sentence to a generative model without dynamically updating the prompt based on structured law revision information, business process analytics, emotion analytics, or actual user adoption of prior recommendations. Consequently, the generative model frequently returns proposals that are not feasible given the organization's system constraints, cost constraints, or technology stack. This degrades the technical effectiveness of the AI component and forces users to manually filter or correct the results. Fourth, conventional factory or equipment-control systems that respond to safety-related legal revisions or working-time regulations are usually separated from compliance analytics systems. Legal revisions may be detected at a policy level, but there is no integrated mechanism by which a processor synthesizes law revision information, business process logs, emotion data from workers, and equipment operation data into a single computational pipeline. As a result, the computer cannot automatically generate and apply adjustment plans for equipment operation or work procedures that are both law-compliant and human-centric. Accordingly, there is a need for a computer-implemented system and method that: (i) automatically acquires law revision information and transforms it into structured, machine-readable legal requirements; (ii) automatically maps these requirements to internal business process information; (iii) integrates multimodal user emotion data and correlates emotion states with specific processes or tasks; (iv) constructs and dynamically refines prompt sentences for a generative AI model based on structured legal data, business process data, emotion context, and user feedback; and (v) in some embodiments, automatically generates and applies both business process changes and equipment-operation adjustments. By addressing these problems as a unified computer-technical improvement, the invention aims to enhance the accuracy, responsiveness, and usefulness of AI-assisted compliance and operations optimization.

The specific processing by the specific processing unit 290 of the data processing device 12 in Application Example 2 is realized by the following means.

The present invention provides a server comprising a processor configured to acquire law revision information from an external information source, preprocess the law revision information as text information, perform natural language processing on the text information to extract revision points and legal requirements of a legal system, and generate structured information as an extraction result; to acquire business process information from an internal information source and specify a business process related to a revision of the legal system by calculating a degree of relevance between the structured information and the business process information; to generate a first prompt sentence for instructing a generative AI model to generate an improvement measure or a countermeasure based on at least the structured information and the specified business process; to input the first prompt sentence to the generative AI model, acquire the improvement measure or the countermeasure output from the generative AI model, and store the improvement measure or the countermeasure as structured data in a storage device; to acquire user emotion data by using an emotion engine that uses at least one of audio information, image information, and biometric information acquired from a terminal device as input, and calculate a user emotion state based on the user emotion data; to specify, by associating the user emotion state with the business process information by at least one of time information and user identification information, a business process that is a cause of stress of a user; to generate an emotion-aware prompt sentence by adding emotion context information including the user emotion state and information on the business process that is the cause of the stress to the first prompt sentence, and to input the emotion-aware prompt sentence to the generative AI model to cause the generative AI model to generate an improvement measure or a countermeasure for a business that satisfies both adaptation to the revision of the legal system and reduction of the stress of the user; to transmit the generated improvement measure or the generated countermeasure to the terminal device and present the generated improvement measure or the generated countermeasure to the user; and to acquire evaluation information or feedback information from the user regarding the generated improvement measure or the generated countermeasure and update a generation condition of the prompt sentence based on at least one of the evaluation information and the feedback information. This enables the processor to implement an integrated computational pipeline that converts unstructured legal texts into structured legal requirements, automatically maps the requirements to business processes, incorporates multimodal emotion analytics to identify stress-inducing workflows, dynamically constructs and refines prompt sentences for the generative AI model based on law data, process data, emotion context, and feedback, and thereby generates and iteratively improves law-compliant and user-centric improvement measures or countermeasures with reduced manual intervention and improved technical performance of the overall computer system.

The term “law revision information” refers to information indicating a change, addition, or deletion in a legal system, including but not limited to revised laws, regulations, rules, guidelines, and official announcements describing such changes.

The term “external information source” refers to an information source outside an organization's internal system, including but not limited to public databases, application programming interfaces, network resources, and document repositories that provide law revision information.

The term “text information” refers to information expressed in a character-based format, including but not limited to plain text, markup text, or encoded document content obtained from law revision information after preprocessing.

The term “preprocessing” refers to a sequence of operations applied to raw data, including but not limited to format conversion, character encoding normalization, removal of control characters or markup, segmentation, and normalization, in order to prepare the data for subsequent analysis.

The term “natural language processing” refers to a computational technique for analyzing human language text, including but not limited to tokenization, part-of-speech tagging, syntactic parsing, named entity recognition, keyword extraction, and semantic analysis.

The term “revision points” refers to specific portions or elements of a legal system that have been changed, added, or deleted as part of a law revision, including but not limited to altered thresholds, new prohibitions, new obligations, or changed effective dates.

The term “legal requirements” refers to normative conditions imposed by a legal system, including but not limited to obligations, prohibitions, limitations, procedural rules, and compliance conditions that an entity is required to satisfy.

The term “structured information” refers to information organized according to a predefined data model, including but not limited to records, fields, and relationships, so that the information can be programmatically accessed, searched, and processed.

The term “internal information source” refers to an information source within an organization's computing environment, including but not limited to internal databases, configuration repositories, log stores, and workflow management systems.

The term “business process information” refers to information describing one or more operations performed by an organization, including but not limited to process definitions, step descriptions, role assignments, timing information, and system interactions.

The term “degree of relevance” refers to a quantitative or qualitative measure that indicates how strongly a first piece of information, such as structured information, is related to a second piece of information, such as business process information.

The term “business process related to a revision of the legal system” refers to a business process for which execution, configuration, or outcome is impacted by at least one revision point or legal requirement extracted from the law revision information.

The term “prompt sentence” refers to a text-based instruction, request, or query supplied to a generative AI model, specifying at least one task, condition, or desired output to guide generation by the generative AI model.

The term “generative AI model” refers to a computational model configured to generate an output such as text, code, or structured data in response to an input, including but not limited to neural-network-based language models and other machine learning models capable of generative inference.

The term “improvement measure” refers to a proposed modification of a business process, system configuration, or operational rule intended to increase compliance, efficiency, reliability, or user experience.

The term “countermeasure” refers to a proposed action or change designed to mitigate a risk, correct a non-compliance, or prevent an adverse effect related to a law revision or an operational problem.

The term “structured data” refers to data arranged in a predefined schema, including but not limited to tables, key-value records, and hierarchical objects, such that each data element has an identifiable type and position.

The term “terminal device” refers to an information processing device used by a user to interact with a server, including but not limited to a personal computer, a mobile device, a tablet, a workstation, or an industrial terminal.

The term “emotion engine” refers to a processing component configured to estimate an emotion state based on one or more input signals, including but not limited to audio signals, image signals, text, and biometric measurements.

The term “user emotion data” refers to data that is usable to estimate or represent a psychological or affective state of a user, including but not limited to speech-derived features, facial-expression features, physiological signals, and sentiment-related text features.

The term “user emotion state” refers to an estimated state of a user's affective condition, including but not limited to stress, frustration, satisfaction, neutrality, or other categorized or scored emotional levels.

The term “audio information” refers to data representing sound acquired from a user, including but not limited to speech, utterances, and vocal expressions captured by a sensor.

The term “image information” refers to data representing visual content acquired from a sensor, including but not limited to still images, video frames, facial regions, and posture images.

The term “biometric information” refers to data derived from a physical or physiological characteristic of a user, including but not limited to heart rate, skin conductance, movement data, and other measurable body-related signals.

The term “time information” refers to information indicating a temporal attribute, including but not limited to timestamps, time intervals, durations, and periodicity associated with events or data records.

The term “user identification information” refers to information that distinguishes one user from another, including but not limited to user identifiers, account identifiers, device identifiers, and pseudonymous tokens.

The term “business process that causes stress of a user” refers to a business process for which execution is correlated with a negative user emotion state, such as an increased stress level, as determined by analysis of user emotion data and business process information.

The term “emotion context information” refers to information representing a context of a user's emotion state, including but not limited to emotion labels, emotion intensities, time ranges, and associated business processes or tasks.

The term “emotion-aware prompt sentence” refers to a prompt sentence that includes emotion context information in addition to legal or operational information, and that is configured to cause a generative AI model to generate an output that accounts for user emotion states.

The term “adaptation to the revision of the legal system” refers to modification of at least one business process, configuration, or system behavior so that the modified operation satisfies legal requirements derived from law revision information.

The term “reduction of the stress of the user” refers to decreasing a negative emotion state level or frequency for at least one user, as determined by comparing user emotion data before and after implementing an improvement measure or countermeasure.

The term “generation condition of the prompt sentence” refers to one or more parameters, rules, or constraints used to create or modify a prompt sentence, including but not limited to target topics, level of detail, cost limits, technology constraints, and format requirements.

The term “evaluation information” refers to information provided by a user or derived from system behavior that evaluates the usefulness, correctness, or feasibility of an improvement measure or countermeasure.

The term “feedback information” refers to information indicating a response or reaction from a user or a system to a previously generated improvement measure, countermeasure, or system action, including but not limited to acceptance, rejection, modification requests, and comments.

The term “adoption status” refers to information indicating whether, how, and to what extent a proposed improvement measure or countermeasure has been implemented, partially implemented, or not implemented in a system or organization.

The term “constraint information” refers to information that limits or guides generation or selection of outputs, including but not limited to cost constraints, feasibility conditions, technology-use conditions, resource limits, and time limits.

The term “cost constraint” refers to a condition specifying a maximum or preferred expenditure level, such as monetary cost, resource consumption, or implementation effort, permissible for an improvement measure or countermeasure.

The term “feasibility condition” refers to a condition indicating whether an improvement measure or countermeasure can be practically realized within given technical, organizational, or regulatory capabilities.

The term “technology-use condition” refers to a condition that constrains or guides the use of certain technologies, platforms, architectures, or components when generating or selecting improvement measures or countermeasures.

The term “work environment data” refers to data that characterizes a physical or virtual work environment, including but not limited to environmental sensor data, workstation status, and contextual information related to work conditions.

The term “equipment operation data” refers to data relating to operation of equipment, including but not limited to machine status, control parameters, movement trajectories, usage logs, and error records.

The term “integration result” refers to data obtained by combining two or more types of information, such as law revision information, business process information, emotion data, work environment data, and equipment operation data, into a unified representation for processing.

The term “change plan of a business process” refers to a plan describing modifications to at least one aspect of a business process, including but not limited to step sequences, timings, role assignments, and system interactions.

The term “adjustment plan of equipment operation” refers to a plan describing modifications to at least one aspect of equipment operation, including but not limited to operation parameters, schedules, modes, and safety margins.

The term “operation parameter of equipment” refers to a controllable parameter influencing operation of equipment, including but not limited to speed, temperature, power, position, timing, or threshold settings.

The term “work procedure” refers to a defined sequence or set of steps that a worker or system is configured to perform to accomplish a particular task or process.

In one embodiment, a server executes a computer program on a computing platform that includes at least one processor, a memory, a non-volatile storage device, and a network interface. The server operates in cooperation with at least one terminal and at least one user. The terminal includes at least one processor, a memory, a display unit, an input unit, and at least one sensor such as a microphone, a camera, or a biometric sensor. The server and the terminal communicate via a communication network using a predefined communication protocol.

Server stores, in the non-volatile storage device, program modules including a law-revision acquisition module, a text preprocessing module, a natural language processing module, a business-process mapping module, a prompt-construction module, a generative-AI interaction module, an emotion-acquisition and analysis module, a feedback-learning module, and, in some embodiments, an equipment-control integration module. Server loads these program modules into the memory and executes them by the processor.

Server uses a general-purpose operating system and a runtime environment that can execute software libraries implementing numerical computation and machine learning. In one embodiment, server uses a machine learning framework, such as a tensor-based numerical computation library, to construct and run neural networks. Server further uses a natural language processing library, such as a tokenization and parsing toolkit, to perform linguistic analysis of text data. Server optionally uses an image-processing library, such as a computer vision toolkit, to process image and video frames when emotion data includes facial information.

Server acquires law revision information by issuing network requests to an external information source. Server uses an HTTP client library to send requests to one or more law or regulation databases that provide law texts and revisions via an application programming interface. Server receives response data, which may be formatted as a structured representation such as JSON, XML, or HTML, and stores the raw data in the storage device. Server converts the raw data into text information by extracting text nodes from markup, normalizing character encodings, and removing extraneous control characters. Server stores both the raw and normalized text information in a persistent data structure, such as a relational table or a document collection.

Server applies the natural language processing module to the normalized text information. Server segments the text into sentences and tokens, assigns part-of-speech tags, and identifies syntactic dependencies. Server further performs named-entity recognition to identify references to legal entities, numeric thresholds, dates, and domain-specific terms such as “maximum weekly working hours” or “encryption strength.” Server then uses rule-based patterns and statistical models to detect revision points by comparing current law texts against previously stored versions or by detecting linguistic patterns that indicate obligations, prohibitions, or changed conditions.

Server organizes the extraction results as structured information. In one embodiment, server stores each revision point as a record containing fields such as a unique identifier, a topic label, a description of the new requirement, an optional description of the previous requirement, an effective date, and a list of affected legal sections. Server indexes these records in a data store configured for efficient query by topic, date, or keyword. This structured organization enables server to perform direct computation of relevance scores and reduces the computational load of repeated text parsing.

Server acquires business process information from an internal information source such as an enterprise workflow database or a system configuration repository. Server obtains descriptions of processes, including textual descriptions, step names, role names, and associated system functions. Server encodes each process description into a numerical representation. In one embodiment, server uses a neural network-based embedding model that maps variable-length text into a fixed-dimensional vector. Server then encodes each law revision description similarly and computes a degree of relevance by calculating a similarity metric such as cosine similarity between embedding vectors. Server optionally applies a threshold or ranking algorithm to determine which business processes are related to each law revision. Because server uses vectorized representations and efficient similarity computations instead of purely rule-based keyword search, server can scale to large numbers of processes and laws with improved processing speed and recall.

Server generates a prompt sentence for a generative AI model by combining fragments of structured information. Server selects relevant fields from the law revision records, such as topic, threshold values, and effective date, and combines them with identifiers and summaries of the affected business processes. Server further inserts instructions concerning desired output structure and constraints. For example, server generates a prompt sentence such as: “Based on a recent revision of labor regulations that lowers the maximum allowed weekly overtime from 45 hours to 40 hours and that takes effect on 2026 Apr. 1, and considering our internal processes ‘Overtime Approval Workflow’ and ‘Shift Scheduling Workflow’, propose detailed improvement measures and countermeasures that ensure legal compliance and minimize operational disruption. Provide the output as a numbered list grouped by responsible role.”

Server optionally adjusts the level of detail and constraints in the prompt sentence based on prior feedback received from the user or based on adoption statistics of previous recommendations.

Server interacts with a generative AI model via a network interface. In one embodiment, the generative AI model is implemented as a multi-layer neural network of the transformer architecture, comprising a plurality of encoder and decoder layers that perform self-attention on token sequences. Server encodes the prompt sentence into tokens according to a tokenizer associated with the generative AI model and transmits the tokenized prompt over a secure connection to an inference endpoint. The generative AI model generates successive tokens by applying learned attention weights and feed-forward transformations, and returns the generated sequence to server. Server decodes the sequence into a text output that contains proposed improvement measures or countermeasures.

Server parses the generated output to identify distinct recommendations. In one embodiment, server uses a parsing module that detects list markers, headings, and key phrases such as “Step 1” or “Action:”. Server converts each recommendation into structured data containing fields such as a short title, a detailed description, an indicated department, and an estimated scope. Server stores the structured recommendations in a recommendations database for later retrieval and analysis.

Terminal provides a user interface that displays the generated recommendations to the user. Terminal retrieves the structured recommendations from server over a secure channel and renders them on a display device. Terminal provides interaction elements such as checkboxes, buttons, and input fields so that user can accept or reject each recommendation or enter comments. Terminal sends the user's evaluation information and feedback information back to server. Server records these responses and aggregates them over time to determine adoption status and effectiveness of different types of recommendations. Terminal acquires user emotion data by using one or more sensors. Terminal captures audio information via a microphone while user provides feedback or performs tasks. Terminal digitizes the audio signal and segments it into frames. Terminal can optionally perform noise reduction and feature extraction, such as computing mel-frequency cepstral coefficients or pitch contours. Terminal sends either the raw audio or derived features to server. Terminal additionally acquires image information by capturing video or still images via a camera positioned to observe the user's face. Terminal uses an image-processing module to detect a face region and extract facial landmarks. Terminal may also acquire biometric information such as heart rate, skin conductance, or motion data via a wearable device connected to the terminal. Terminal encapsulates the emotion-related signals together with timestamps and user identification information and transmits them to server.

Server uses an emotion engine to calculate a user emotion state from the received user emotion data. In one embodiment, server implements the emotion engine as a neural network comprising convolutional layers for image features, recurrent or transformer layers for audio features, and dense layers for fusion of multiple modalities. Server inputs extracted facial landmark coordinates, audio features, and biometric features to respective subnetworks and concatenates intermediate representations into a joint feature vector. Server then computes emotion scores, for example as probabilities over categories such as “neutral,” “stressed,” and “frustrated,” by applying a softmax layer. Server stores the resulting emotion state along with the associated time information and user identification information in an emotion log. Server associates the emotion logs with business process information. Server cross-references timestamps of emotion records with timestamps from operation logs or workflow logs that indicate which process or step the user was executing during that time. Server thereby identifies business processes that correlate with increased stress or negative emotion states. Server computes statistics such as the frequency of high-stress states during execution of each process and identifies a “business process that causes stress of a user” when the frequency exceeds a threshold. Because server performs this association using machine-generated emotion states and structured process logs, the system can detect patterns and correlations that are not readily observable by manual review, and can do so for large volumes of data in real time.

Server generates an emotion-aware prompt sentence by adding emotion context information to a base prompt sentence. For example, after detecting that a particular overtime approval workflow frequently coincides with high stress, server generates a prompt sentence such as: “In the overtime approval workflow, user emotion analysis shows frequent high-stress states and negative sentiment. A recent revision of labor regulations lowers the maximum allowed weekly overtime from 45 hours to 40 hours. Propose improvement measures and countermeasures that both ensure compliance with the new regulation and reduce user stress during the overtime approval workflow. Include changes to user interface, approval rules, and notification timing, and describe each measure in detail.”

Server inputs this emotion-aware prompt sentence to the same generative AI model. Because the prompt sentence now includes emotion context and explicit constraints, the generative AI model generates recommendations that jointly address legal and human factors. Server parses and structures these emotion-aware recommendations similarly to prior recommendations and marks them with metadata indicating that they are derived from emotion-aware prompts. Server updates a generation condition of prompt sentences using evaluation information and feedback information from user. Server analyzes adoption status by checking which recommendations have been implemented or marked as accepted in downstream systems. Server may compute performance indicators such as subsequent changes in violation rates or error frequencies, although those aspects are not strictly required. Based on this analysis, server adjusts constraint information, such as cost limits, required technology compatibility, or preferred implementation timeframes, included in future prompt sentences. For example, when user repeatedly rejects recommendations that require replacement of core systems, server modifies the prompt-construction rules so that future prompt sentences explicitly instruct the generative AI model to avoid full-system replacement and to favor incremental configuration changes. This dynamic adjustment of the prompt generation conditions results in improved quality and practicality of AI-generated outputs and reduces the number of irrelevant or infeasible recommendations presented to the user.

In another embodiment, server integrates work environment data and equipment operation data with law revision information, business process information, and emotion data. Server acquires equipment operation data from industrial control systems, such as motion parameters, speeds, and tool positions of robotic equipment. Server also acquires work environment data, such as proximity sensor readings, temperature, or noise levels, that may influence worker safety and stress. Server stores these data streams in time-synchronized records. When a new safety-related law revision is detected, server extracts structured legal requirements such as “minimum separation distance” or “maximum speed near human operators.” Server then constructs a prompt sentence that includes the legal requirements, descriptions of current equipment operation patterns, and summaries of worker stress patterns near particular machines. For example, server generates a prompt sentence such as: “In a factory assembly line, equipment operation data show that a robot arm operates at high speed within 0.5 meters of workers at Station 3. Work environment data and emotion analysis indicate frequent high stress for workers at Station 3. A new safety regulation requires a minimum separation distance of 1.0 meter or a reduced speed mode when a human is present within 1.0 meter. Propose a detailed adjustment plan for robot operation parameters and work procedures that ensures compliance with the regulation and reduces worker stress, while maintaining throughput as much as possible.”

Server inputs such a prompt sentence to the generative AI model and receives a proposed adjustment plan describing new speed profiles, motion paths, or scheduling policies. Server translates this plan into specific operation parameters, such as revised velocity limits for certain segments of a robot trajectory, new safety zone configurations, or modified sequence timings. Server then sends these updated parameters to the equipment controller via an appropriate protocol. Because server's processing combines legal constraints, multi-source operational data, and emotion-related data into a single computational workflow, and applies the result directly to control of equipment, the system produces a technical effect beyond mere automation of human reasoning. The system improves computing efficiency and decision precision in generating law-compliant and human-aware control parameters and enables real-time or near-real-time adaptation that would be impractical for human operators alone.

In still another embodiment, server implements the generative AI model locally. Server constructs a neural network of the transformer type with multiple attention heads and layers. Server trains this model using a corpus that includes historical law texts, internal policy documents, and prior accepted recommendations. During training, server uses an objective function such as cross-entropy loss between predicted tokens and ground-truth tokens for next-token prediction or masked token prediction. Server updates model weights using an optimization algorithm such as stochastic gradient descent with adaptive learning rates. Server applies regularization and data augmentation techniques such as random masking of tokens, shuffling of clause order within constraints, or paraphrasing of process descriptions. These techniques improve the model's robustness and generalization capabilities when generating recommendations for new law revisions and process configurations.

Server in some embodiments configures the emotion engine as a separate neural network trained on multimodal datasets containing labeled emotion states. Server defines an error function for classification accuracy, such as categorical cross-entropy between predicted emotion class distributions and labeled ground-truth classes. Server updates network weights using gradient-based optimization and validates the network on held-out datasets. By explicitly describing the architecture and training procedures, the implementation enables reproducible and technically grounded emotion estimation rather than an abstract “AI judgment.”

Server, terminal, and user cooperate in various alternative configurations. In one variant, terminal performs part of the preprocessing and feature extraction locally, transmitting only feature vectors, not raw sensor data, to server. This reduces communication bandwidth and protects user privacy. In another variant, terminal caches recent recommendations and emotion states locally, so that terminal can continue operation in a degraded mode when connectivity to server is temporarily unavailable. In yet another variant, server distributes different functions across multiple machines, such as assigning the generative-AI interaction module to a dedicated accelerator node and the emotion engine to a node equipped with specialized graphics processing units. These variations preserve the essential data flows described above while allowing adaptation to different deployment environments. By transforming unstructured law texts into structured information, by mapping such information to structured business process representations using numerical embeddings and similarity computations, by integrating multimodal emotion states, and by dynamically constructing and refining prompt sentences for a generative AI model based on feedback and operational data, the system achieves several technical effects. Server reduces the latency and computational waste associated with repeatedly parsing large law texts; server improves the precision and recall of law-to-process mapping through vector similarity operations; server reduces the number of irrelevant or infeasible recommendations through feedback-driven prompt conditioning; and server, in equipment-control embodiments, enables automatic and fine-grained adjustment of operation parameters in response to legal and human factors. These effects collectively represent improvements to the functioning of the computer system itself, including faster processing of regulatory changes, more accurate relevance determinations, reduced communication overhead, and technically enhanced control of equipment, rather than mere automation of human business judgment.

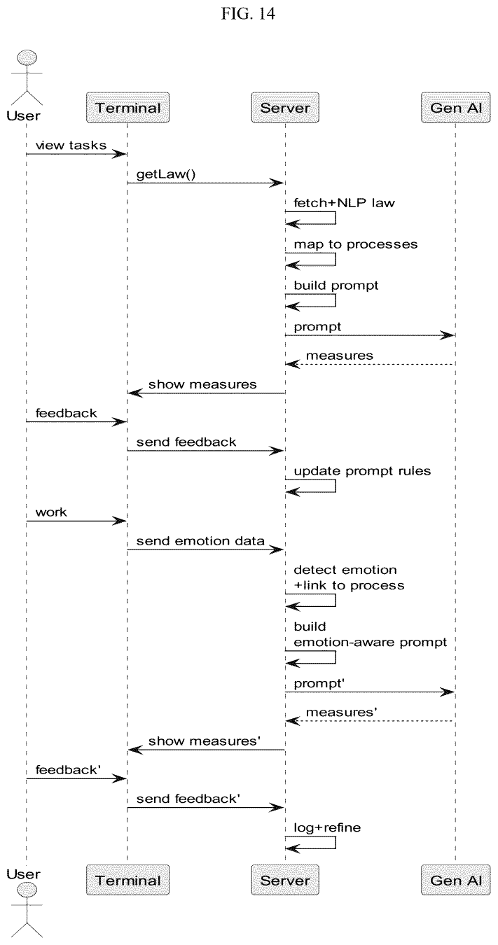

The following describes the processing flow using FIG. 14.

### Step 1:

Server acquires law revision information from an external information source.

Server uses a network interface to send an HTTP request to at least one external database or API that provides legal texts and revision notices. As input, server receives response data in a structured or semi-structured format, such as JSON, XML, or HTML. Server parses the response to extract textual content, removes markup tags, normalizes character encoding, and concatenates multi-part documents into a single text string. As output, server produces normalized text information representing one or more law revisions and stores this text information in a storage device.

### Step 2:

Server performs natural language processing on the normalized text information to extract revision points and legal requirements.

Server takes the normalized law text as input and applies a natural language processing library to tokenize the text into sentences and words, assign part-of-speech tags, and perform syntactic parsing. Server uses pattern-matching rules and comparison with previously stored versions of the law (if available) to detect changed thresholds, added or removed obligations, and new effective dates. Server then groups detected clauses by topic (for example, working-time limits, data protection, safety distances) using keyword-based clustering or topic modeling. As output, server generates structured information, such as records where each record contains a topic label, a description of the new requirement, an optional description of an old requirement, and an effective date.

### Step 3:

Server acquires business process information and computes a degree of relevance between the structured information and the business process information.

Server retrieves process descriptions, step names, and associated metadata from an internal database as input. Server converts each business process description and each law revision description into numerical vectors using a text-embedding method. Server calculates similarity scores between the vectors using a metric such as cosine similarity. Server then filters or ranks business processes for each revision point based on the similarity scores. As output, server produces a list of “related business processes” for each law revision record, each entry including an identifier of the process and a relevance score.

### Step 4:

Server generates a first prompt sentence for a generative AI model based on the structured information and the related business processes.

Server takes as input the structured law revision records and the list of related business processes. Server composes a natural-language instruction that describes the legal changes, names or summarizes the affected processes, and specifies the desired type and format of output. For example, server may generate a prompt sentence such as: “Based on a recent revision of labor regulations that lowers the maximum allowed weekly overtime from 45 hours to 40 hours and affects the ‘Overtime Approval Workflow’ and ‘Shift Scheduling Workflow’, propose detailed improvement measures and countermeasures that ensure legal compliance and minimize operational disruption. Provide the output as a numbered list grouped by responsible role.”

Server concatenates these elements into a single text string. As output, server obtains a well-formed prompt sentence ready to be submitted to a generative AI model.

### Step 5:

Server sends the prompt sentence to a generative AI model and receives generated improvement measures or countermeasures.

Server uses the prompt sentence as input and encodes it into tokens according to the tokenization rules of the generative AI model. Server transmits the token sequence to a model inference endpoint via a secure network connection. The generative AI model then processes the token sequence using internal attention and feed-forward layers to compute the probability distribution for each next token and generate a sequence representing an answer. Server receives the generated token sequence and decodes it back into a human-readable text. As output, server obtains a text response that includes one or more candidate improvement measures or countermeasures.

### Step 6:

Server parses the generated text response and converts it into structured data. Server takes the generated text from the generative AI model as input. Server applies text-parsing rules to identify list items, headings, and key markers such as numbers, bullet points, or keywords (“Action,” “Step,” “Department”). Server segments the text into individual recommendations and extracts attributes such as a title, a detailed description, a recommended responsible role, and a priority. Server performs data normalization, for example trimming whitespace and unifying field formats. As output, server produces a set of structured records representing each improvement measure or countermeasure, and stores them in a recommendations database.

### Step 7:

Terminal requests and displays the structured recommendations to the user.

Terminal sends a request to server specifying user identity and context (for example, department or current task) as input. Server returns structured recommendation records that are relevant to that user. Terminal receives the records and generates a user interface layout, grouping recommendations by topic, process, or priority. Terminal renders the resulting lists and details on a display device, allowing scrolling and selection. As output, terminal presents visual representations of the recommendations and associated metadata to user.

### Step 8:

User reviews the recommendations and provides evaluation information or feedback information.

User observes the recommendations on the terminal display as input. User selects one or more recommendations and provides responses such as “accept,” “reject,” “requires modification,” or text comments describing constraints or concerns. Terminal captures these interactions as structured feedback data including recommendation identifiers, evaluation labels, and optional free-text comments. Terminal transmits this feedback data to server. As output, user generates and terminal delivers evaluation information and feedback information to server.

### Step 9:

Server updates generation conditions for future prompt sentences based on evaluation information and adoption status.

Server receives evaluation and feedback records as input. Server aggregates this data over multiple recommendations and over time, computing statistics such as acceptance rate, common reasons for rejection, or typical cost constraints mentioned by user. Server then adjusts internal parameters that control prompt construction: for example, server may decide to add explicit constraints such as “avoid full system replacement” or “limit proposals to configurations achievable within three months” in future prompt sentences. Server updates a profile of generation conditions associated with the user or the organization. As output, server maintains updated rules and parameters that will influence the content and structure of subsequent prompt sentences.

### Step 10:

Terminal acquires user emotion data using sensors and sends the emotion data to server. Terminal uses a microphone, camera, and optionally a wearable interface as inputs. Terminal records audio of user speech and captures image frames of the user's face. Terminal optionally reads biometric signals such as heart rate from a connected device. Terminal aligns these signals with timestamps and user identifiers. Terminal may perform local preprocessing such as noise reduction, face detection, or feature extraction to reduce data size. Terminal then packages the audio-related features, image-related features, biometric values, timestamps, and identifiers into a message. As output, terminal produces a multimodal user emotion data packet and transmits it to server.

### Step 11:

Server calculates a user emotion state from the user emotion data and associates the emotion state with business process information.

Server receives the emotion data packet as input. Server applies an emotion-engine model, such as a neural network trained to classify stress levels from combined audio, image, and biometric features. Server computes intermediate features and then outputs emotion scores (for example, probabilities of “neutral,” “stressed,” or “frustrated”). Server writes these emotion states into an emotion log along with timestamps and user identification information. Server then queries internal workflow logs to identify which business process and which process step were active at the corresponding timestamps for that user. Server correlates the emotion states with the process logs to count occurrences of high-stress states per process. As output, server generates a mapping from processes to stress metrics and identifies at least one business process that causes stress of a user.

### Step 12:

Server generates an emotion-aware prompt sentence and obtains emotion-aware improvement measures from the generative AI model.

Server uses as input the previously generated base prompt sentence, the mapping from processes to stress metrics, and the identified stress-causing processes. Server appends emotion context information—such as “employees frequently experience high stress during Step X of Process Y”—to the base prompt, forming an emotion-aware prompt sentence. For example, server generates a prompt sentence such as:

“In the overtime approval workflow, user emotion analysis shows frequent high-stress states. A recent revision of labor regulations lowers the maximum weekly overtime. Propose improvement measures and countermeasures that ensure compliance with the new regulation and reduce user stress during the overtime approval workflow.”

Server submits this emotion-aware prompt sentence to the generative AI model, receives a generated response, and parses the response as in previous steps. As output, server obtains a set of emotion-aware improvement measures or countermeasures structured in a machine-readable form.

### Step 13:

Server selects and transmits emotion-aware recommendations to terminal and updates logs. Server takes as input the structured emotion-aware recommendations and the user's profile and context. Server filters the recommendations to those that are relevant to the current user or process and may prioritize them based on stress reduction potential or legal impact. Server packages the selected recommendations into a response and transmits them to terminal. Server also logs which recommendations have been delivered to which user and at what time, for later analysis of adoption status. As output, server provides terminal with a tailored set of emotion-aware recommendations.

### Step 14:

Terminal displays emotion-aware recommendations and collects user reactions.

Terminal receives the emotion-aware recommendations as input from server. Terminal integrates these items into the existing recommendation interface, optionally highlighting them as stress-reduction measures or law-critical measures. Terminal allows user to inspect the detailed descriptions and to provide reactions such as “this reduces workload” or “not applicable to my team.” Terminal captures these reactions and returns them to server as additional feedback data. As output, terminal presents emotionally prioritized suggestions and captures refined user feedback that further informs the server's learning process.

### Step 15:

Server, in an equipment-control embodiment, integrates law revision information, business process information, emotion data, and equipment operation data to generate and apply equipment adjustment plans.

Server collects structured law revision records related to safety or operation limits, internal process information describing how operators interact with equipment, emotion logs showing stress levels near specific stations, and equipment operation data such as robot speed profiles and positions. Server uses these as input to construct a detailed prompt sentence that describes current operational parameters, law requirements, and observed stress patterns. Server sends this prompt to the generative AI model and receives a text description of recommended adjustments, such as reduced speeds in certain zones or modified task sequences. Server translates these text recommendations into specific equipment operation parameters and configuration commands. Server then transmits these commands to a controller of the equipment. As output, server updates the operational behavior of equipment so that it conforms to revised legal requirements and is aligned with reduced operator stress.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

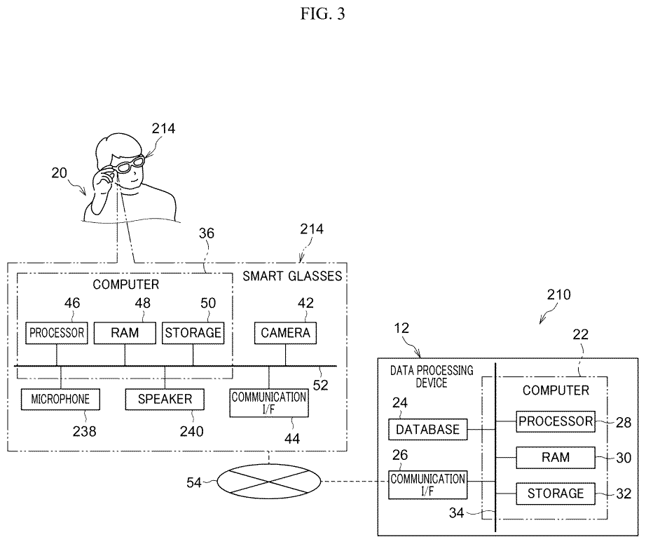

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

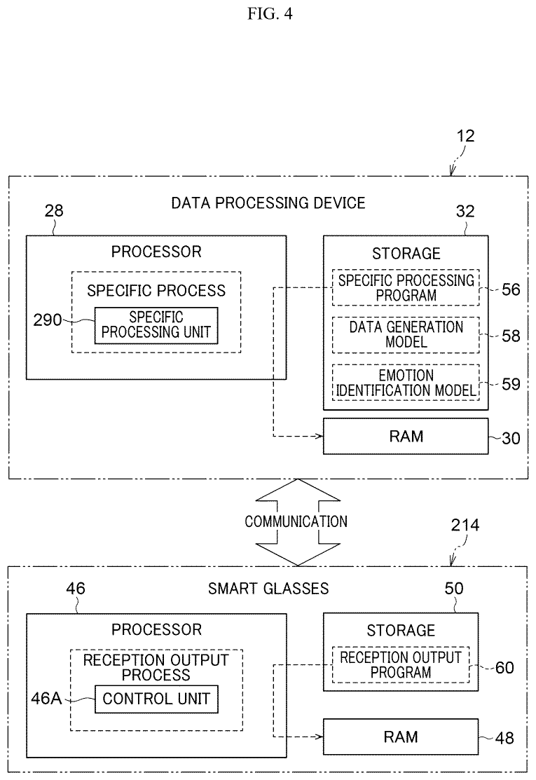

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

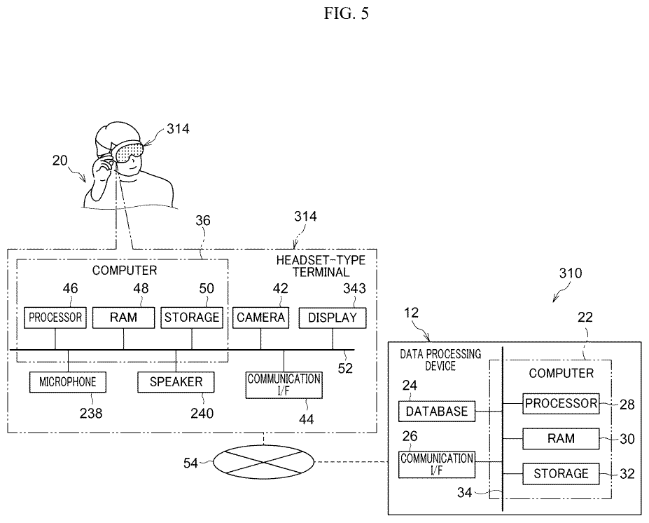

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

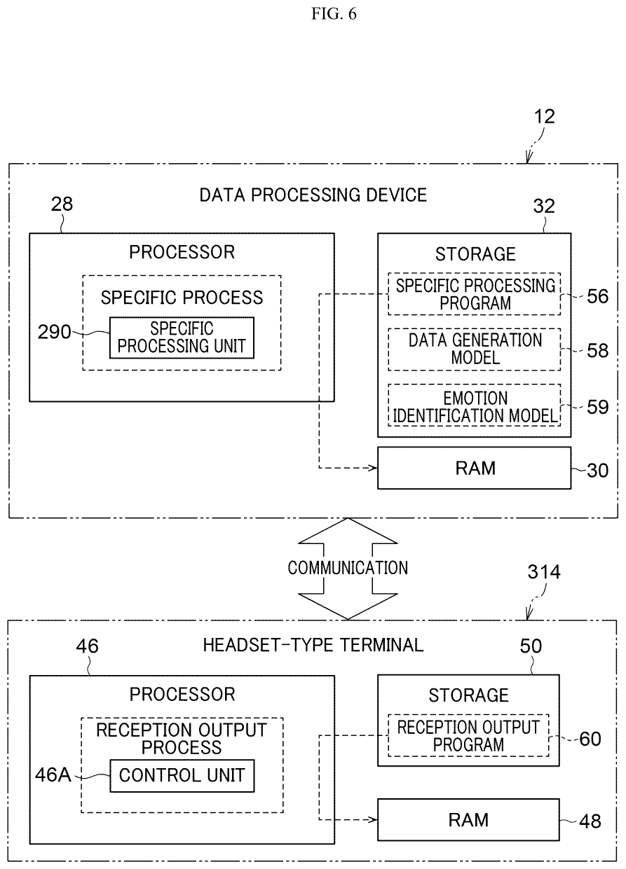

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

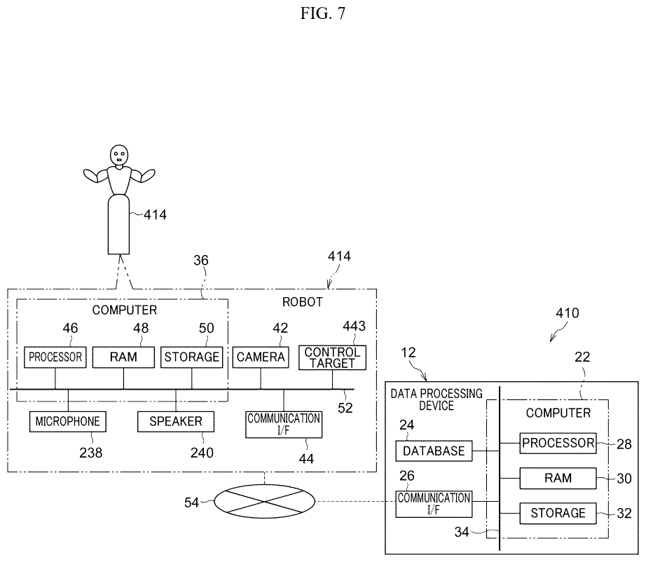

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

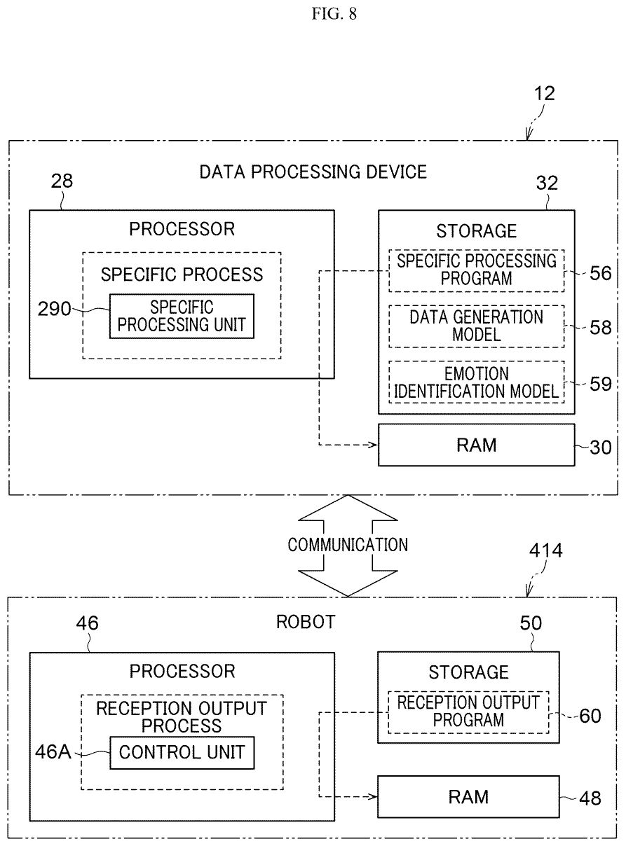

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

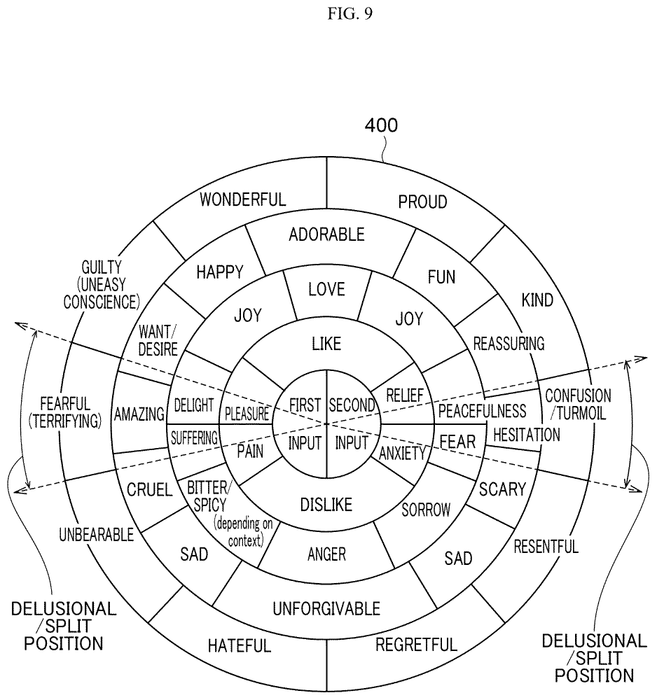

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

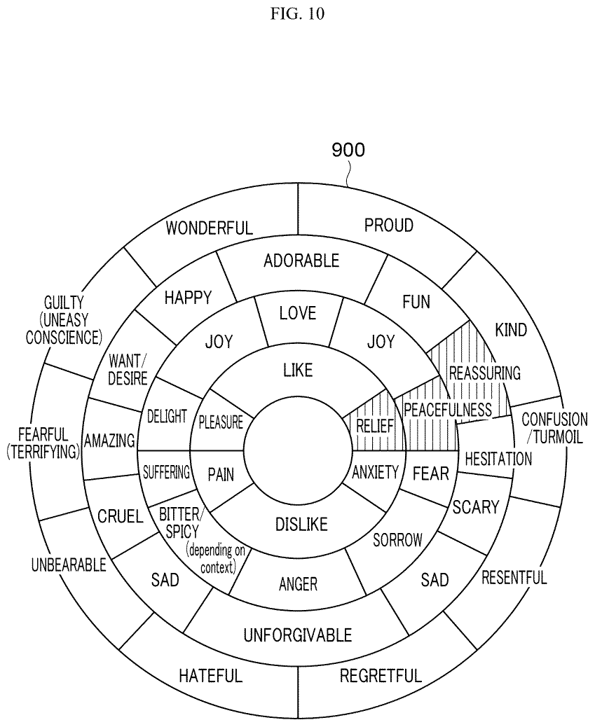

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire and analyze legal revision information from an external information source, acquire business procedure information and organization information that are associated with the legal revision information from a business processing device and an information storage device, normalize the business procedure information, and store the normalized business procedure information on a business unit basis and a procedure unit basis,
construct and train a machine learning model on the basis of the stored business procedure information and the legal revision information, and calculate an impact degree for specifying a business related to a legal revision,
specify, on the basis of the impact degree, a business to be affected and an element of a business procedure of the business, and store a specification result as structured data, automatically generate a prompt sentence, from input data including the structured data and the legal revision information, for instructing a generative artificial intelligence model to create improvement measures and countermeasure plans, and transmit the prompt sentence to the generative artificial intelligence model,
acquire the improvement measures and the countermeasure plans output from the generative artificial intelligence model, associate the improvement measures and the countermeasure plans with the specified business and business procedure, store and aggregate the associated improvement measures and countermeasure plans, and format the aggregated improvement measures and countermeasure plans as output data,
acquire user emotion data by using an emotion processing device that performs emotion estimation processing to acquire user state information, associate the emotion data with the improvement measures and the countermeasure plans, analyze the associated data, and propose business improvement measures, and
notify a user of the business improvement measures, the countermeasure plans, and proposal content based on the emotion data via a display device or a communication device.

### (Supplementary 2)

The system according to supplementary 1,
wherein the processor is configured to
cause the machine learning model to execute classification processing or regression processing for predicting, on the basis of the business procedure information, the organization information, and past legal revision information, the impact degree of a legal revision on each business, and to automatically specify the business to be affected on the basis of a result of the classification processing or the regression processing.

### (Supplementary 3)

The system according to supplementary 1,
wherein the processor is configured to
configure the prompt sentence to include summary information of the legal revision information, identification information on the business and the business procedure to be affected, organization attribute information, and implementation deadline information, store a generation history of the prompt sentence as record information, and execute processing for sequentially improving content of the prompt sentence on the basis of the record information.

### Application Example 1

### (Supplementary 1)

A system comprising a processor,
wherein the processor is configured to
acquire information on a legal system revision from an external information source and perform character string processing and natural language processing on the information to structure the information as structured data, and
generate a prompt sentence that instructs a generative information processing model to identify an impact of the legal system revision on internal business rules of an organization based on the structured data, input the prompt sentence into the generative information processing model, and extract candidates of the business rules affected by the legal system revision from an output of the generative information processing model, and
associate the extracted candidates of the business rules with a list of the business rules stored in a storage device by using semantic vector similarity calculation or character string matching, and specify the business rules affected by the legal system revision, and generate a prompt sentence that instructs the generative information processing model to generate concrete improvement measures and countermeasures as stepwise procedures for each of the specified business rules based on the specified business rules and the information on the legal system revision, and automatically generate the improvement measures and the countermeasures by using the prompt sentence, and
format the automatically generated improvement measures and countermeasures as notification information in a format that is easy for a human to view and execute, and transmit the notification information to a user terminal, and
acquire an implementation status and modification instruction from a user from the user terminal, associate the implementation status and the modification instruction with the improvement measures and the countermeasures, record the implementation status and the modification instruction, and update at least one of contents of the prompt sentence and generation rules of the improvement measures and the countermeasures based on the record, and
use an emotion processing function to collect emotion information of the user to recognize an emotion of the user, and analyze the emotion information in association with business improvement measures based on the information on the legal system revision to propose the business improvement measures.

### (Supplementary 2)

The system according to supplementary 1,
wherein the processor is configured to
update discrimination parameters for specifying business operations related to a legal system revision and generation rules of the prompt sentence by machine learning using the information on the legal system revision acquired from the external information source and feedback information acquired from the user terminal.

### (Supplementary 3)

The system according to supplementary 1,
wherein the processor is configured to
generate a plurality of types of prompt sentences to be input to the generative information processing model, the plurality of types of prompt sentences including a summary of the information on the legal system revision, identification information of the specified business rules, and a requested output format for the specified business rules, and dynamically adjust selection or contents of the plurality of types of prompt sentences based on the feedback information.

### Example 2

### (Supplementary 1)

A system comprising a processor,
wherein the processor is configured to
acquire information relating to a legal or regulatory amendment from an external information source and from a terminal, and preprocess the information relating to the legal or regulatory amendment by using natural language processing so as to perform at least one of character string normalization, word segmentation, sentence boundary detection, and part-of-speech assignment,
extract, from the preprocessed information relating to the legal or regulatory amendment, elements corresponding to at least one of obligations, prohibitions, thresholds, and penalties, and, based on the extracted elements, generate summary information of the legal or regulatory amendment and identify business processes that are affected by the legal or regulatory amendment,
construct an instruction sentence for input to a generative AI model by using the summary information of the legal or regulatory amendment and information relating to the affected business processes, and generate the instruction sentence as a prompt sentence,
input the prompt sentence to the generative AI model, obtain response information relating to improvement measures and countermeasures for the business in accordance with the legal or regulatory amendment from the generative AI model, perform post-processing to convert the response information into structured data, and output the post-processed improvement measures and countermeasures to the terminal,
acquire emotion data by using an emotion recognition function in order to recognize a user emotion, and, based on the emotion data and the response information obtained from the generative AI model, adjust at least one of content and presentation manner of the improvement measures and the countermeasures, and
store, in an associated manner, the acquired information relating to the legal or regulatory amendment, the prompt sentence, the response information, and evaluation information from the user, and update processing for generating the prompt sentence and identifying the affected business processes based on the stored information.

### (Supplementary 2)

The system according to supplementary 1,
wherein the processor is configured to
identify the affected business processes by using a machine learning model to estimate business process classifications from the information relating to the legal or regulatory amendment, and determine the affected business processes based on a correspondence between the estimated business process classifications and predefined business processes.

### (Supplementary 3)

The system according to supplementary 1,
wherein the processor is configured to
generate an internal representation including the summary information of the legal or regulatory amendment, the affected business processes, and business environment information acquired from the user, and automatically construct the prompt sentence by applying the internal representation to template information that defines instruction content and output format for the generative AI model.

### Application Example 2

### (Supplementary 1)

A system comprising a processor,
wherein the processor is configured to
acquire law revision information from an external information source and perform preprocessing on the law revision information as text information,
perform natural language processing on the text information to extract revision points and legal requirements of a legal system and generate structured information as an extraction result,
acquire business process information from an internal information source and specify a business process related to a revision of the legal system by calculating a degree of relevance between the structured information and the business process information,
generate a prompt sentence for instructing a generative AI model to generate an improvement measure or a countermeasure based on the structured information and the specified business process,
input the prompt sentence to the generative AI model, acquire the improvement measure or the countermeasure output from the generative AI model, and store the improvement measure or the countermeasure as structured data,
acquire user emotion data by using an emotion engine that uses at least one of audio information, image information, and biometric information acquired from a terminal device as input, and calculate a user emotion state based on the user emotion data,
specify, by associating the user emotion state with the business process information by time information or user identification information, a business process that causes stress of a user, generate an emotion-aware prompt sentence by adding emotion context information including the user emotion state and information on the business process that causes the stress to the prompt sentence, and input the emotion-aware prompt sentence to the generative AI model to cause the generative AI model to generate an improvement measure or a countermeasure for a business that satisfies both adaptation to the revision of the legal system and reduction of the stress of the user, and
transmit the generated improvement measure or countermeasure to the terminal device, present the generated improvement measure or countermeasure to the user, acquire evaluation information or feedback information from the user, and update a generation condition of the prompt sentence based on the evaluation information or the feedback information.

### (Supplementary 2)

The system according to supplementary 1,
wherein the processor is configured to analyze an adoption status of the improvement measure or the countermeasure acquired from the generative AI model and the evaluation information from the user, and automatically add constraint information including at least one of a cost constraint, a feasibility condition, and a technology-use condition to the prompt sentence based on an analysis result, thereby dynamically adjusting a subsequent prompt sentence.

### (Supplementary 3)

The system according to supplementary 1,
wherein the processor is configured to integrate the law revision information, the business process information, the emotion data, and at least one of work environment data and equipment operation data acquired from the terminal device, input a prompt sentence including an integration result to the generative AI model to cause the generative AI model to generate a countermeasure including both a change plan of a business process and an adjustment plan of equipment operation, and automatically update at least one of an operation parameter of equipment and a work procedure based on the countermeasure.

What is claimed is:

1. A system comprising:
circuitry configured to:
acquire and analyze regulatory revision information from an external information source via a communication interface coupled to a packet-switched network, and store the regulatory revision information in a storage device;
acquire business procedure information and organization information associated with the regulatory revision information from an internal processing device and an internal information storage device via the communication interface, normalize the business procedure information, and store the normalized business procedure information in the storage device;
generate a prompt sentence based on the regulatory revision information and the normalized business procedure information, input the prompt sentence to a generative AI model to generate an improvement plan, and collect user emotion data via an emotion analysis engine based on data received from a terminal device via the communication interface; and
adjust the improvement plan based on the collected user emotion data, and transmit the adjusted improvement plan to the terminal device via the communication interface.

2. The system according to claim 1, wherein the circuitry is configured to acquire regulatory revision information from an external information source via the communication interface, identify and extract revision items from the acquired regulatory revision information, and store the revision items in the storage device.

3. The system according to claim 2, wherein the circuitry is configured to acquire business procedure information and organization information from an internal processing device via the communication interface, normalize the business procedure information, and identify affected business operations based on the regulatory revision items.

4. The system according to claim 3, wherein the circuitry is configured to generate the prompt sentence incorporating the regulatory revision items, the normalized business procedure information, and the affected business operations, and input the prompt sentence to the generative AI model to obtain the improvement plan.

5. The system according to claim 4, wherein the circuitry is configured to parse the improvement plan output from the generative AI model to extract structured fields including affected workflow identifiers, recommended changes, and implementation timelines, and store the structured fields in the storage device.

6. The system according to claim 1, wherein the circuitry is configured to collect user emotion data by applying the emotion analysis engine to at least one of text data, vocal characteristics, and behavioral patterns received from the terminal device via the communication interface.

7. The system according to claim 6, wherein the circuitry is configured to adjust at least one of a content emphasis, a presentation format, and a priority ordering of the improvement plan based on the collected user emotion data.

8. The system according to claim 1, wherein the circuitry is configured to monitor external information sources for regulatory revision updates via the communication interface, detect new revisions, and automatically trigger generation of updated improvement plans for affected business procedures.

9. The system according to claim 8, wherein the circuitry is configured to compare updated regulatory revision information with previously stored revision information, identify changes, and generate a prompt sentence incorporating the identified changes to obtain an incremental update to the improvement plan.

10. The system according to claim 1, wherein the circuitry is configured to generate a prompt sentence instructing the generative AI model to assess the impact of regulatory revision items on a plurality of business procedure categories, and incorporate the impact assessment into the improvement plan.

11. The system according to claim 10, wherein the circuitry is configured to rank the impact assessment items by severity, and generate an improvement plan that prioritizes business procedures with the highest impact scores.

12. The system according to claim 1, wherein the circuitry is configured to receive, from the terminal device, feedback on the transmitted improvement plan via the communication interface, incorporate the feedback into the storage device, and refine the prompt sentence for subsequent improvement plan generation.

13. The system according to claim 12, wherein the circuitry is configured to store a record of regulatory revision items, improvement plans, and associated feedback in the storage device, and use the stored records to improve prompt sentence construction for future regulatory revisions.

14. The system according to claim 1, wherein the circuitry is configured to generate a progress tracking report by incorporating compliance status data received from the terminal device into a prompt sentence for the generative AI model, and transmit the progress tracking report to the terminal device via the communication interface.

15. The system according to claim 14, wherein the circuitry is configured to detect deviations between expected compliance progress and actual compliance status based on the progress tracking report, and generate an updated improvement plan to address the detected deviations.

16. The system according to claim 1, wherein the circuitry is configured to transmit adjusted information to a display device via the communication interface, and cause the adjusted information to be presented in a format adapted to the user emotion data.

17. The system according to claim 16, wherein the circuitry is configured to monitor changes in the user emotion data received from the terminal device over a session, and update the presentation format of the improvement plan in response to detected emotional state transitions.

18. A system comprising:
circuitry configured to:
acquire regulatory revision information from an external information source and business procedure information from an internal processing device via a communication interface coupled to a packet-switched network, and store the information in a storage device;
generate a prompt sentence incorporating the regulatory revision information and the normalized business procedure information, input the prompt sentence to a generative AI model to generate an improvement plan, and collect user emotion data via an emotion analysis engine;
adjust the improvement plan based on the collected user emotion data; and
transmit the adjusted improvement plan to a terminal device via the communication interface, and update the storage device based on feedback received from the terminal device.

19. The system according to claim 18, wherein the circuitry is configured to monitor external information sources for regulatory revision updates via the communication interface, detect new revisions, automatically trigger generation of updated improvement plans, and transmit the updated plans to the terminal device.

20. A method comprising:
acquiring regulatory revision information from an external information source and business procedure information from an internal processing device via a communication interface coupled to a packet-switched network, and storing the information in a storage device;
generating a prompt sentence based on the regulatory revision information and the normalized business procedure information, inputting the prompt sentence to a generative AI model to generate an improvement plan, and collecting user emotion data via an emotion analysis engine; and
adjusting the improvement plan based on the collected user emotion data, and transmitting the adjusted improvement plan to a terminal device via the communication interface.
